(19) United States
(12) Patent Application Publication
(10) Pub. No.: US 2015/0254226 A1
(43) Pub. Date: Sep. 10, 2015

(54) Spreadsheet Tool for Dimensional Calculations

(71) Applicants: Anthony A. Renshaw, New York, NY (US); Carl Edward Renshaw, Hanover, NH (US)

(72) Inventors: Anthony A. Renshaw, New York, NY (US); Carl Edward Renshaw, Hanover, NH (US)

(21) Appl. No.: 14/640,855

(22) Filed: Mar. 6, 2015

Related U.S. Application Data
(60) Provisional application No. 61/948,753, filed on Mar. 6, 2014.

(51) Int. Cl. G06F 17/24

(52) U.S. Cl. CPC G06F 17/246

(57) ABSTRACT

Spreadsheet-based tools for converting dimensional quantities from one set of dimensional units to another quickly and efficiently as well as correctly and automatically performing mathematical calculations using dimensional and dimensionless quantities are described. More particularly, the computer-based systems, methods and spreadsheet software perform mathematical calculations with both dimensional and dimensionless quantities, allowing extensive flexibility and customization so that both the user input and the computer output use the units that are most useful and convenient.

### FIELD OF INVENTION

The present invention relates to spreadsheet-based tools for converting dimensional quantities from one set of dimensional units to another quickly and efficiently as well as correctly and automatically performing mathematical calculations using dimensional and dimensionless quantities, variables, and functions. More particularly, the computer-based systems, methods and spreadsheet software perform mathematical calculations with both dimensional and dimensionless quantities, allowing extensive flexibility and customization so that both the user input and the computer output use the units that are easiest, most useful, and convenient.

### BACKGROUND OF THE INVENTION

Mathematical and engineering calculations using dimensional quantities are ubiquitous in spreadsheet applications such as Microsoft Excel™, Lotus 1-2-3™, Google™ Spreadsheets, and Open Office Calc™. These calculations range from converting units (e.g., converting from the United States Customary System of Units of inches, feet, and pounds to equivalent metric units such as meters, kilograms and Newtons; or, alternatively converting monetary values from one currency to another) to formulas taking various input dimensional quantities to compute a dimensional output quantity (e.g.; computing the power of an engine from its torque and angular velocity).

Several U.S. patents describing dimensional computations and data management of dimensional quantities using spreadsheets include the following.

U.S. Pat. No. 5,471,575 by Giansante, which is incorporated by reference herein in its entirety, describes a financial analysis in a spreadsheet that includes dimensional quantities such as rent, home prices, and tax rates.

U.S. Pat. No. 5,910,899 by Barrientos, which is incorporated by reference herein in its entirety, describes a method for performing a timing analysis for an integrated circuit floorplan within a spreadsheet in which variables such as delays and clock cycles must be defined in terms of units of time and distance.

U.S. Pat. Nos. 6,148,656, 6,382,014, and 6,470,732 by Breton, all of which are incorporated herein by reference in their entirety, describe using spreadsheets to manage and compute data related to exhaust gas flow rates and mass flow rates of pollutants from automobiles.

U.S. Pat. No. 6,134,535 by Belzberg, which is incorporated by reference herein in its entirety, describes a computerized stock exchange trading system based on a spreadsheet for managing and exporting dimensional quantities such as stock prices, stock trades sizes in shares, and measures of time.

U.S. Pat. Nos. 6,957,385 and 7,549,117 by Chan et al., which are incorporated herein by reference in their entirety, describe using worldwide number formats within a spreadsheet, where the worldwide number format includes a locale specifier of the number and a base format of the number.

U.S. Pat. No. 7,020,537 by Wilson et al., which is incorporated by reference herein in its entirety, describes a process for electrochemically processing a microelectronic workpiece that involves spreadsheet output with numerous dimensional output quantities.

U.S. Pat. No. 7,120,544 by Duncan, which is incorporated by reference herein in its entirety, describes a turbulent flow analysis tool that may be implemented in a spreadsheet that involves numerous dimensional input and output quantities.

U.S. Pat. No. 7,136,785 by Mast et al., which is incorporated by reference herein in its entirety, describes a system for statistically analyzing a structural member such as a bolted joint by inputting design data into a spreadsheet. In the example provided, some of the dimensional input includes design criteria with dimensions such as mm, MPa, and N-mm.

U.S. Pat. Nos. 7,390,866, 7,605,217, 7,928,165 and 8,013,093 by Datta et al., which are incorporated herein by reference in their entirety, describe using a spreadsheet to manage data related to chemical elastomers and their manufacture. The units associated with this data include temperature, heats of fusion and weight percent composition.

U.S. Pat. Nos. 7,620,584, 8,560,428 and 8,635,149 by Lynn et al., which are incorporated herein by reference in their entirety, describe using a spreadsheet to manage the trading of financial instruments whose dimensional properties include prices, shares, and currency.

U.S. Pat. Nos. 7,996,327 and 8,392,338 by Ren et al., which are incorporated herein by reference in their entirety, describes a product efficiency calculator that may be implemented in a spreadsheet that includes dimensional quantities involving gallons, pounds, liters and cubic feet.

U.S. Pat. Nos. 8,577,652 and 8,626,477 by Oh, which are incorporated herein by reference in their entirety, describe using a spreadsheet to model engineering systems. Examples of dimensional quantities involved in the spreadsheet calculations cited include vehicle loads and speeds.

U.S. Pat. No. 8,583,530 by Esbensen, which is incorporated by reference herein in its entirety, describes financial models in a spreadsheet that include dimensional quantities such as ages, time periods, monetary values, and death rates.

U.S. Pat. No. 8,355,827 by Egnor et al., which is incorporated by reference herein in its entirety, describes a product energy calculator that may be implemented in a spreadsheet that includes dimensional quantities involving temperatures and power consumption.

Despite their ubiquity in engineering, financial, insurance, manufacturing, and inventory applications, spreadsheet tools for managing dimensional quantities and calculations involving dimensional quantities are rudimentary. For example, in U.S. Pat. Nos. 6,148,656, 6,382,014, and 6,470,732, Breton “remove[d] units from the data” to make “the data readily useable in a spreadsheet.”

In U.S. Pat. No. 7,136,785 by Mast et al., the spreadsheet includes “predefined equations” relevant to structural analysis envisioned. Although the spreadsheets described involve numerous dimensional computations and many changes on design variables to assess different “what if” scenarios, the invention does not indicate or hint at methods to enable users to input, edit, and manage dimensional calculations of their own.

Perhaps more typical, U.S. Pat. Nos. 8,577,652 and 8,626,477 by Oh cite numerous dimensional computations but do not mention converting or manipulating the units of the input or output dimensional quantities within the spreadsheets. Instead, as written, the input dimensions and formulas programmed in the spreadsheet are for a fixed set of dimensional units.

In other cases, the prior art provides no indication of how such conversions or calculations might be performed within a spreadsheet application. U.S. Pat. No. 8,355,827 by Egnor et al. discusses using different temperature measurements, e.g., temperatures measured in Fahrenheit, Celsius, and Kelvin, for example, but gives no indication as to how that might be accomplished.

Although standard spreadsheet programs sometimes provide rudimentary tools for converting units, the tools are so rudimentary that they can be difficult to use effectively and often cause mistakes themselves. Such tools may require the user to correctly type in accurate input and output units in a standard, inflexible syntax. Each spreadsheet reference, or link, between cells with numerical values and dimensional units must be manually referenced or linkup by the user. For even relatively simple equations, this approach is a tedious and error prone process. Most importantly, they do not have the capability to detect when an equation has a dimensional inconsistency. Such inconsistency is a fundamental flaw.

Dimensional consistency is required when computing formulas using dimensional quantities. For example, when adding two dimensional quantities together, both dimensional quantities must represent the same kind of dimensional measurement. For example, it is dimensionally consistent to add inches and meters together because both of these units of measure refer to length. However, it is dimensionally inconsistent to add inches and kilograms together because these units of measure refer to different kinds of measurements, namely length and mass, respectively. Dimensional consistency requires knowing not just the units of measure used for the input dimensional quantities, but also the kind of measurement each unit refers to. The same kinds of measurements can be consistently added and subtracted together regardless of the particular units used (e.g., inches and meters). That is dimensionally consistent. Different kinds of measurements—such as length, mass, or time—cannot be added or subtracted from each other. That is dimensionally inconsistent. All the mathematical functions have corresponding rules for what is and is not a consistent dimensional computation. When adding and subtracting, the measurement of the arguments must all be the same. When multiplying and dividing, any measurements are allowed, as the multiplying and dividing naturally create the appropriate units of the result.

Microsoft Excel™, manufactured by Microsoft Corporation, of Redmond, Wash., can convert units by using the software function “Convert” located in the Analysis ToolPak add-in. Once Excel™ has converted units, the user can program various dimensional calculations using the results. However, Microsoft Excel™ does not perform any consistency checks on calculations, so the accuracy of the result is subject to human error. For example, it is possible to convert a calculation such as ten times twelve from seconds to hours even if the intended calculation was ten meters times twelve meters. In addition, Microsoft Excel™ has a number of other drawbacks. For combinations of units, the units must be converted one after another rather than all at once. This approach is tedious and error prone. Since the calculations are embedded in Microsoft Excel™ Worksheets, they are not immediately visible to the user and debugging them is also tedious and error prone. Since the conversion tool is very simple, it often gives incorrect answers. For example, to convert temperature from 212 degrees Fahrenheit to degrees Celsius, the function call is CONVERT(212, “F”, “C”), which correctly gives the answer of 100. However, if the user tries to embed a calculation such as converting the difference of 212 degrees Fahrenheit and 32 degrees Fahrenheit to degrees Celsius using the function call CONVERT(212−32, “F”, “C”), the answer returned is 82.22. In this case, the computation performed by the computer is ((212−32) degrees Fahrenheit)=(212 degrees Fahrenheit)=82.2 degrees Celsius. That may not, and, most likely, is not what the user intended. Since 212 degrees Fahrenheit=100 degrees Celsius and 32 degrees Fahrenheit=0 degrees Celsius, the user may have wanted to obtain the result ((212 degrees Fahrenheit)−(32 degrees Fahrenheit))=((100 degrees Celsius)−(0 degrees Celsius))=100 degrees Celsius. In this case, the unwieldy syntax used by Microsoft Excel's Convert function may have contributed to an unintentional unit conversion error.

Defects and disadvantages with existing spreadsheet tools for converting and calculating dimensional equations include the following. It is easy to make fundamental mistakes, such as the temperature error just described. All conversions must be done separately. For a single dimensional value that has many base units in its dimension, conversion may require multiple calls to the CONVERT function. These multiple calls are tedious and error prone. Further, although spreadsheets have the ability to program equations and formulas, they do not have the ability to check these equations for dimensional consistency. These are tremendous limitations.

One of the most important features of spreadsheets is the ability to reference or link cells to each other in order to, for example, perform calculations using the data in more than one cell. Existing spreadsheet tools do not possess the ability to easily and accurately link cells that contain dimensional data, nor do they possess the ability to identify incorrectly linked cells, for example, dimensionally inconsistent formulas.

There have been and are spreadsheet based “add-ins” developed for unit conversion. For example Octavian Micro Development Inc. (formerly located at www.octavian.com/excel.html; now at http://octavian.co/) used to provide a unit conversion tool in the form of an Excel™ addin. Unfortunately, this tool suffers a number of disadvantages. The syntax chosen is cumbersome in that all compound units must be separated by the multiplication character ‘*’ and the division symbol, ‘/’, is not recognized. As a result, the input symbols are significantly different than customarily encountered. For example, rather than expressing velocity as “m/s”, one must type “m*ŝ−1”. This is significantly more typing and much more difficult to read and interpret. Perhaps more importantly, this tool does not accept equations or allow equations to be checked for dimensional consistency.

The lack of easy to use, inexpensive spreadsheet tools for performing dimensional computations has resulted in a strange phenomenon in the way that undergraduate engineering is taught. Despite the fact that most undergraduate engineers possess their own computers, most students still perform engineering calculations involving units manually. They do not use conversion tools. Some write down input values on a sheet of paper, convert then with a hand held calculator, and then do the homework problem with the converted values. Others enter the original input dimensional quantities into Excel™, convert them individually within Excel™ as needed, and then set up the equations using converted dimensional input quantities. While this approach may have some pedagogical value, it is tedious and error prone. Furthermore, this procedure is implicitly encouraged by textbooks that give the same example problems twice, once in US Customary System of Units and then once in metric units. See, for example, R. E. Sonntag, C. Borgnakke, and G. J. Van Wylen, Fundamentals of Thennodynamics (Sixth Edition), Chapter 2, John Wiley & Sons, 2003, which is incorporated by reference herein in its entirety. Such pedagogical procedures would not be necessary or, perhaps even tolerated, if a readily accessible tool were available within spreadsheets for automatically and correctly performing dimensional computations.

There are a variety of United States patents and published applications related to tools for efficient conversion of dimensional quantities.

U.S. Pat. No. 4,319,130 by Spitzer, which is incorporated by reference herein in its entirety, describes an electronic calculator and keyboard that can input dimensional quantities and process dimensional equations.

U.S. Pat. No. 4,881,189 by Proctor, which is incorporated by reference herein in its entirety, describes a computer program that can input dimensional quantities and process dimensional equations.

U.S. Pat. No. 5,216,627 by McClellan, which is incorporated by reference herein in its entirety, describes a hand-held calculator that can parse unit strings, convert units, and perform calculations with dimensional quantities.

U.S. Pat. No. 5,379,239 by Nakatani, which is incorporated by reference herein in its entirety, describes a waveform display that can input dimensional quantities and display a graphical representation of dimensional output.

U.S. Pat. No. 6,167,412 by Simons, which is incorporated by reference herein in its entirety, describes a hand-held calculator for performing medical computations involving medical dimensional quantities.

U.S. Pat. No. 6,598,186 by McGuire, which is incorporated by reference herein in its entirety, describes a computer representation of dimensional quantities that allows dimensional inconsistency errors to be detected and reported.

U.S. Pat. No. 7,058,931 by Pai, which is incorporated by reference herein in its entirety, describes importing a non-executable data structure into a computer program so that unit conversions may be performed.

U.S. Patent Application Publication No. 2001/0011241 by Nemzow, which is incorporated by reference herein in its entirety, describes a dynamic currency conversion system for managing financial transactions.

U.S. Patent Application Publication No. 2003/0101204 by Watson, which is incorporated by reference herein in its entirety, describes a generic unit conversion system.

U.S. Pat. No. 7,457,837 by Baumann, which is incorporated by reference herein in its entirety, describes a system for performing quantized dimensional conversions to precisely manage manufacturing and production systems with known accuracy limits.

U.S. Pat. No. 7,788,306 by Dykes, which is incorporated by reference herein in its entirety, describes a system which converts units embedded within a document such as a web page or a word processing document based on mouse or cursor positioning and hovering.

U.S. Patent Application Publication No. 2008/00115056 by Escapa, which is incorporated by reference herein in its entirety, describes a method for parsing equations within a document such as a web page or a word processing document and automatically computing the result of the equation.

U.S. Pat. No. 8,015,078 by Scalora et al., which is incorporated by reference herein in its entirety, describes a system for displaying inventory items in multiple units of measure such as sheets, square yards, square feet, or pounds.

These patents and publications possess common features that are helpful for describing unit conversion tools.

First, the prior art recognizes that two pieces of data are required to define a dimensional quantity. The first piece of data is a numerical value and the second piece of information is a representation of the dimensional unit or unit of measure associated with the numerical value. In the prior art, the first part, the numerical value, is termed a “numeric part” in Spitzer, a “numeric value” in Proctor; a “numerical value” in Nakatani; a “numeric value” by McGuire; a “numeric value” by Watson; a “scalar part” in McClellan; and a “numerical value” by Dykes. The second piece of information, the dimensional unit or unit of measure associated with the numerical value, is termed a “homoscriptive unit representing the unit of measurement” by Spitzer; a “unit-factor”by Proctor; an “indication of the measuring unit” in Nakatani; a “units designation” by McGuire; a “unit string” in Watson; a “unit part” in McClellan; and a “native unit” by Dykes.

Pai describes an “offset” which is a third piece of information that may be needed for unit conversion but is not part of the user input or output. For example, when converting temperature from Fahrenheit to Celsius, the liner transformation involves a constant offset term as well as a linear slope term. Hence, the conversion involves two numerical values, the constant term and the linear term. However, since this third piece of information in neither input by the user nor output by the prior art, it is not part of the two-part representation of a dimensional quantity just described that pertain only to user inputs and outputs.

The second common feature in the prior art is how the library of possible units is defined, managed, and processed both for input and output. In most cases, the library consists of a small set of base units that can be combined in the numerator or denominator of the dimensional measure. For example, Spitzer uses the example of “km/hr” representing speed measured in kilometers per hour. This is what he terms a “homoscriptive unit representing the unit of measurement”. In this case, the internal representation of the dimensional unit is defined in terms of the base unit “km” which appears in the numerator and “hr” which appears in the denominator. In addition to the base units, the library of possible units also includes commonly used names of units that can be converted dynamically into a combination of base units. For example, since one horsepower is equivalent to 745.7 kg m̂2/ŝ3, horsepower can be represented by base units kilograms (“kg”) in the numerator, meters (“m”) raised to the power two in the numerator, and seconds (“s”) raised to the power three in the denominator. By reducing arbitrary dimensional units into combinations of base units, the user is allowed to input and output results in convenient units.

The third feature of comparison in the prior art is the mechanism for entering and displaying output. Most of the prior art uses alphanumeric keyboards to input text strings that are parsed into the numeric value and base units. Displays are used to show calculated results. This combination of keyboard and display includes handheld calculators such as described in McClellan and Simons, as well as traditional, computer-based keyboards and displays such as described by Spitzer, Proctor, McGuire, and Watson. Alternatives to keyboard and display configurations have been described. For example, Dykes uses a pointer controlled by a mouse and a pop-up window to perform calculations on or in a document such as a webpage, while Escapa describes parsing strings found within a text editor. Scalora proposes using either a tool-as-tip display, a callout window, a pull-down menu, or even a verbal announcement to display a dimensional quantity.

A fourth aspect of comparison across the prior art is whether or not in addition to converting dimensional quantities from one set of units to another, the prior art also parses and computes formulas or equations involving the dimensional inputs. Nakatani, Pai, Watson and Dykes limit themselves to unit conversion, while Spitzer, Proctor, McGuire, McClellan, Simons, and Escapa describe performing calculations on dimensional formulas and equations.

Despite the prior art and various features that have been proposed for improving unit conversion tools, the tools for converting units and managing dimensional equations within spreadsheets remain rudimentary.

This remains true even though the prior art includes a large number of inventions whose sole aim is to improve the ease of use and accuracy of spreadsheets.

U.S. Pat. No. 5,603,021 by Spencer et al., which is incorporated by reference herein in its entirety, describes a wizard or dialog box for assisting users in entering, understanding, and correcting formulas in spreadsheet cells.

U.S. Pat. No. 5,701,499 by Capson et al., which is incorporated by reference herein in its entirety, describes populating the cell entries of a spreadsheet by dragging the border of a cell over new cells, a feature that is standard in some existing spreadsheet software.

U.S. Pat. No. 5,721,847 by Johnson, which is incorporated by reference herein in its entirety, describes a toolbar or dialog box for controlling and managing the displayed format of spreadsheet cells, a feature that is standard in some existing spreadsheet software.

U.S. Pat. No. 5,842,180 by Khanna et al., which is incorporated by reference herein in its entirety, describes a wizard or dialog box for suggesting and either accepting or rejecting corrections to spreadsheet formulas that contain errors, a feature that is standard in some existing spreadsheet software.

U.S. Pat. No. 5,890,174 by Khanna et al., which is incorporated by reference herein in its entirety, describes a wizard or dialog box for assisting users in entering formulas in spreadsheet cells, a feature that is standard in some existing spreadsheet software.

U.S. Pat. No. 5,987,481 by Michelman et al., which is incorporated by reference herein in its entirety, describes an improved method for referencing a range of cells in a spreadsheet using label references.

U.S. Pat. Nos. 6,055,548 and 6,430,584 by Corner et al., which are included here by reference in their entirety, describe automatically calculating selected formula results for any selected or highlighted range of cells and displaying the result on the display automatically. The calculation of the average, count, and sum of a selected set of cells is a feature that is standard in some existing spreadsheet software.

U.S. Pat. No. 6,112,214 by Graham et al., which is incorporated by reference herein in its entirety, describes automatically copying, moving, or extending cells in a spreadsheet by clicking on the border of the selected cells and, together with control keys, dragging and dropping the border to a new position. This feature is standard in some existing spreadsheet software.

U.S. Pat. No. 6,115,759 by Sugimura et al., which is incorporated by reference herein in its entirety, describes a system for managing and controlling the display and storage of large spreadsheets.

U.S. Pat. No. 6,411,313 by Conlon et al., which is incorporated by reference herein in its entirety, describes using a drag-and-drop form to assist spreadsheet users in creating a PivotTable in a spreadsheet.

U.S. Pat. No. 6,766,509 by Sheretov et al., which is incorporated by reference herein in its entirety, describes a procedure for tracking the execution sequence of spreadsheet cells and providing feedback on the validity of the spreadsheet cell formulas.

U.S. Pat. Nos. 6,779,151 and 7,099,890 by Cahill et al., which are incorporated herein by reference in their entirety, describe methods for obtaining and embedding data in a spreadsheet cell from an external data source.

U.S. Pat. Nos. 6,986,099 and 7,665,013 by Todd, which are incorporated herein by reference in their entirety, describe providing error messages when spreadsheet copying and pasting results in cell formula errors.

U.S. Pat. No. 7,117,430 by Maguire, III et al., which is incorporated by reference herein in its entirety, describes a method beyond the traditional spreadsheet error messaging for displaying, selecting, and correcting from a list of possible cell formula errors in a spreadsheet when a potential error is found in the formula of a spreadsheet cell. For example, one of the examples of a possible error is “Inconsistent Formula”. However, the user must enter his or her response to these errors outside the cells of the spreadsheet, which is not the case with the present invention.

U.S. Pat. No. 7,222,294 by Coffen et al., which is incorporated by reference herein in its entirety, describes automatically extending the formatting of cells in a spreadsheet by comparison to neighboring cell formats.

U.S. Pat. No. 7,318,192 by Hobbs, which is incorporated by reference herein in its entirety, describes methods for formulaically bounding cell data displayed in the cells of a spreadsheet.

U.S. Pat. No. 7,415,481 by Becker et al., which is incorporated by reference herein in its entirety, describes improved semantic designations for spreadsheet data that may have advantages over traditional explicit cell location references.

U.S. Pat. No. 7,426,688 by Serra et al., which is incorporated by reference herein in its entirety, describes automatically updating a cell of a spreadsheet using a formula embedded in a comment attached to the cell.

U.S. Pat. No. 7,444,584 by Hobbs, which is incorporated by reference herein in its entirety, describes methods for formulaically controlling the evaluation of spreadsheet formulas that reference other cells in the spreadsheet.

U.S. Pat. No. 7,640,489 by Breuer, which is incorporated by reference herein in its entirety, describes a method for reversibly altering the contents of a spreadsheet cell to observe the resulting spreadsheet calculation without overwriting cell contents.

U.S. Pat. No. 8,621,340 by Chirilov et al., which is incorporated by reference herein in its entirety, describes improved method for managing the automatic propagation of editing commands on blocks of spreadsheet cells.

In addition to these U.S. patents that describe features for improving the ease of use and utility of spreadsheets, a number of U.S. patents describe multi-dimensional data manipulation within a spreadsheet. U.S. Pat. Nos. 8,145,990 and 8,386,916 by Le Brazidec et al., which are incorporated herein by reference in their entirety, describe systems and methods for creating a multidimensional expression calculated member in a spreadsheet cell.

U.S. Pat. No. 7,805,433 by Dickerman, which is incorporated by reference herein in its entirety, describes the use of multidimensional cube functions within spreadsheets.

U.S. Patent Application No. 2003/0009649 by Martin, which is incorporated by reference herein in its entirety, describes an invention for the dynamic conversion of spreadsheet formulas to multidimensional calculation rules.

### SUMMARY OF THE INVENTION

Despite some superficial similarities in the prior art, the present invention is substantially different than this prior art.

First, the prior art described in patents such as those addressed above relates to manipulating multidimensional business data such as different product lines, profit values, customer groups, fiscal years, distribution regions, product costs, product quantities, revenues, and/or dates stored in a database external to the spreadsheet application. The present invention relates to the manipulation of a data within a spreadsheet where the data is input using two cells of the spreadsheet. The first cell contains a numerical value and the second cell contains the associated dimensional units. The two cells could be considered a two dimensional data point. Furthermore, since a spreadsheet can be considered a simple database, the fact that the present invention describes the manipulation of two-dimensional data within a spreadsheet, it is possible to describe that as multi-dimensional data within a database.

However, there are clear differences. The database in the prior art is external to the spreadsheet application, whereas in the present invention there is no external database, just the spreadsheet itself. Second, when the prior art describes “converting Excel formulas” such as “D3-E3” (Le Brazidec et al.), whatever other dimensions may be associated with cells D3 and E3 are external to the spreadsheet and stored in the external database. Whatever rules are required for manipulating formulas involving the multidimensional data are located and managed within the external database, not within the spreadsheet. Finally, the final result of a multi-dimensional computation is always displayed in a single cell in the prior art. This is not true of the present invention, since the present invention produces two dimensional output, requiring at least a pair of cells to hold the two components of a dimensional output quantity.

A second aspect of the present invention that is similar to but different than an existing feature in some spreadsheet functions is the spreadsheet array formulas. In Microsoft Excel™, one can use what are called array formulas which are special functions that can produce output in more than one cell. For example, the function “TREND” takes a vector of input cells and determines a corresponding number of straight-line values for the line that best fits the input cell values. The arguments of “TREND” are the input cells and the cells for the output straight-line values. To produce the output in more than one cell, the user must not just type the formula but also select the output cells, and then click Ctrl-Shift-Enter while the input formula bar is selected. This multi-step approach encloses the formula in braces and forces output to the desired output cells.

The present invention also populates more than one cell of the spreadsheet when an indication is given by the user. This approach begins in a manner similar to the user typing Ctrl-Shift-Enter for array functions. However, the existing array formulas in spreadsheets do not permit dimension input quantities in pairs of cells to be consistently processed and output to a pair of output cells. The existing array functions do not process dimensional calculations. Furthermore, all input cells must be included in the array function. These limitations are not true of the present invention.

In summary, despite a wealth of prior art, there remains a need for tools that enable students and professionals to quickly, efficiently, and correctly compute dimensional equations within a spreadsheet environment and detect whenever dimensional errors or inconsistencies are present.

There is also a need for spreadsheet tools to be easy to use and require minimal typing and expertise.

There is a need for spreadsheet tools that can take multiple input values in any units and compute a formula correctly whose output can be displayed in any consistent units without having the user perform or program any of the conversions.

There is a need for a spreadsheet tool that can parse combinations of base input units to derive a complicated dimensional unit.

There is a need for spreadsheet tools that will check dimensional formulas and equations for dimensional consistency.

There is a need for spreadsheet tools to provide information when there are any mistakes or inconsistencies in the input, the formula, or the output units so that these can be quickly corrected. Such a computer-based method or system would help prevent costly errors related to dimensional computations and the conversion of dimensional units.

Therefore, there is a need for inexpensive, readily accessible, easy to use spreadsheet tools that are less cumbersome than existing tools for performing dimensional computations and unit conversion within a spreadsheet environment. To such ends, one aspect of the present invention addresses a spreadsheet tool that correctly handles and performs calculations using dimensional quantities, automatically converting units as necessary within equations, outputting answers in user-selected default or explicit units, and indicating when inconsistencies are present in the calculations so that errors can be identified and corrected.

The present application describes aspects and features of a spreadsheet tool in accordance with the present invention, and gives some illustrative examples of how it can be used. A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIGS. 2A-2B (collectively FIG. 2) show an illustration of a prior art spreadsheet, illustrating and distinguishing the contents of various cells from what is displayed in the cells;

FIGS. 3A and 3B (collectively FIG. 3) show an illustration of an example spreadsheet display button icons that may be used to perform the present invention;

FIG. 4 shows an illustrative prior art spreadsheet display output;

FIG. 5 shows the cell contents of the prior art spreadsheet display of FIG. 4;

FIG. 6 shows an illustrative spreadsheet display output using the present invention;

FIG. 7 shows the cell contents of the spreadsheet display of FIG. 6;

FIGS. 8A and 8B (collectively FIG. 8) provide an input instruction and display table, as well as, a spreadsheet display for an illustrative example using the present invention;

FIGS. 9A, 9B and 9C (collectively FIG. 9) provide an instruction and display table, the cell contents and the spreadsheet display, respectively, for an illustrative example using the present invention;

FIGS. 10A, 10B and 10C (collectively FIG. 10) provide an instruction and display table, the cell contents and the spreadsheet display, respectively, for an illustrative example using a prior art spreadsheet approach for contrast with the present invention;

FIGS. 11A, 11B and 11C (collectively FIG. 11) provide an instruction and display table, the cell contents and the spreadsheet display, respectively, for an illustrative example using a prior art spreadsheet approach for contrast with the present invention;

FIGS. 12A, 12B and 12C (collectively FIG. 12) provide an instruction and display table, the cell contents and the spreadsheet display, respectively, for an illustrative example using the present invention;

FIGS. 13A, 13B and 13C (collectively FIG. 13) provide an instruction and display table, the cell contents and the spreadsheet display, respectively, for an illustrative example using the present invention;

FIGS. 14A, 14B and 14C (collectively FIG. 14) provide an instruction and display table, the cell contents and the spreadsheet display, respectively, for an illustrative example using the present invention;

FIGS. 15A, 15B and 15C (collectively FIG. 15) provide an instruction and display table, the cell contents and the spreadsheet display, respectively, for an illustrative example using the present invention;

FIGS. 16A, 16B and 16C (collectively FIG. 16) provide an instruction and display table, the cell contents and the spreadsheet display, respectively, an illustrative example using the present invention;

FIGS. 17A, 17B and 17C (collectively FIG. 17) provide an instruction and display table, the cell contents and the spreadsheet display, respectively, for an illustrative example using the present invention;

FIGS. 18A, 18B and 18C (collectively FIG. 18) provide an instruction and display table, the cell contents and the spreadsheet display, respectively, for an illustrative example using the present invention;

FIGS. 19A, 19B and 19C (collectively FIG. 19) provide an instruction and display table, the cell contents and the spreadsheet display, respectively, for an illustrative example using the present invention;

FIGS. 20A, 20B and 20C (collectively FIG. 20) provide an instruction and display table, the cell contents and the spreadsheet display, respectively, for an illustrative example using the present invention;

FIGS. 21A, 21B and 21C (collectively FIG. 21) provide an instruction and display table, the cell contents and the spreadsheet display, respectively, for an illustrative example using the present invention;

FIG. 22 illustrates a flow chart of the steps of a process in accordance with an embodiment of the present invention;

FIG. 23 illustrates a flow chart of the steps of a process in accordance with an embodiment of the present invention; and,

FIG. 24 illustrates a flow chart of the steps of a process in accordance with an embodiment of the present invention.

FIG. 25 shows a circuit implementation of one embodiment of the present invention.

### DETAILED DESCRIPTION

The present invention may be suitably implemented as a computer-based system, in computer software which is stored in a non-transitory manner and which resides on computer readable media, such as solid state storage devices, RAM, ROM, or the like, other storage devices such as a magnetic hard disk drives, USB flash memory devices, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

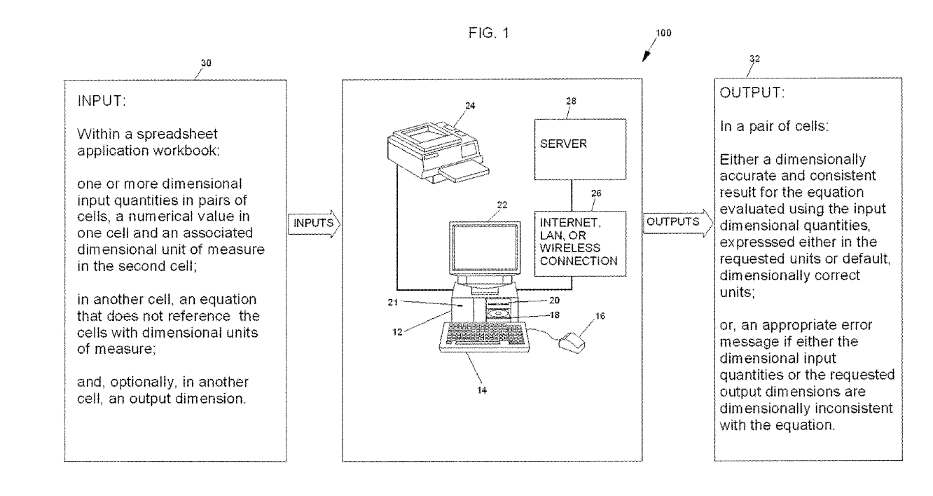

FIG. 1 shows a block diagram of a computer system 100 which may be suitably used to implement the present invention. System 100 is implemented as a computer or mobile device 12 including one or more programmed processors, such as a personal computer, workstation, server, or mobile device. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22. The output could also be sent electronically through the Internet, LAN, or wireless connection 26. In another embodiment of the invention, the entire software is installed and runs on the computer or mobile device 12, and the Internet or LAN or wireless connection 26 and server 28 are not needed.

As shown in FIG. 1 and described in further detail below, the system 100 includes software that is run by the central processing unit of the computer or mobile device 12. Alternatively, the invention may be embodied in an integrated circuit embodiment. The computer or mobile device 12 may suitably include a number of standard input and output devices, including a keyboard 14, a mouse 16, CD-ROM/CD-RW/DVD drive 18, disk drive or solid state drive 20, monitor 22, and printer 24. The computer or mobile device 12 may also have a USB connection port 21 which allows external hard drives, flash drives and other devices to be connected to the computer or mobile device 12 and used when utilizing the invention. It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an iPad™, iPhone™, iPod™, Blackberry™, Treo™, or the like. The invention could also be installed entirely on a portable device such as an Apple iPhone™. In fact, a portable installation such as an Apple iPhone™ may be ideal for some contexts.

One embodiment of the invention has been designed as a downloadable Addin file for use in conjunction with an Excel™ spreadsheet installed on a stand-alone personal computer running the Microsoft Windows™ 7 operating system. In this embodiment, the Addin file is downloaded, the Excel™ spreadsheet program is opened and the Addin is installed. Another embodiment of the invention has been designed as a downloadable Addin for use in conjunction with an Excel™ spreadsheet operating on a stand-alone personal computer running the MAC™ OS 10.9 “Mavericks” operating system, Apple Inc.'s desktop and server operating system for Apple computers. While a software embodiment is presently preferred and predominantly described, it will be recognized the invention can be embodied in circuit based designs such as a calculator, in which application specific integrated circuits (ASICs) and circuit modules replace software modules and software instructions.

According to one aspect of the invention, it is contemplated that the computer or mobile device 12 will be operated by a person in an office, classroom, library, study setting, or casual setting to work with entries having a numerical value, as well as, an associated dimensional unit in an advantageous manner as described further below.

As illustrated in FIG. 1, and as described in greater detail below, additional inputs 30 may suitably include within a spreadsheet workbook application, one or more dimensional input quantities in pairs of cells, a numerical value in one cell and an associated dimensional unit of measure in the second cell; in another cell, an equation that does not reference the cells with dimensional units of measure; and, optionally, in another cell, an output dimension.

As further illustrated in FIG. 1, and as described in greater detail below, the system outputs 32 may suitably include within a pair of cells, either a dimensionally accurate and consistent result for the equation evaluated using the input dimensional quantities, expressed either in the requested units or default, dimensionally correct units; or, an appropriate error message if either the dimensional input quantities or the requested output dimension are dimensionally inconsistent with the equation.

The output information may appear on the monitor 22 or may also be printed out at the printer 24. The output information may also be electronically sent to an intermediary for interpretation. Other devices and techniques may be used to provide outputs, as desired.

In a preferred embodiment, spreadsheet applications such as Microsoft Excel™, Lotus 1-2-3™, Google™ Spreadsheets, and Open Office Calc™ are modified and used as taught herein, but as appreciated by those skilled in the art, any robust electronic spreadsheet application can be modified and used in the system of the present invention. The standard spreadsheet application can be modified with “add in” programming to provide the user interfaces, simplify certain operations in the spreadsheet and to support the functionality described herein. Commercial spreadsheets have allowed users to input “add in” features to enhance their capabilities. However, it will be recognized the invention could also be built into an integrated circuit embodiment employing an ASIC, FPGA or the like. In the preferred embodiment, the user of the system programs one or more sheets in the spread sheet application to reflect the dimensional input quantities and dimensional formulas he or she wishes to compute.

In general, embodiments of the present invention relate to a method for managing dimensional equations within spreadsheet programs that reference data based on cell coordinates (i.e. “C6” or “D3:D12”) or indices. Embodiments of the invention comprise the new method for entering, creating, editing, and performing computations on dimensional data or quantities, as well as, displaying such results.

The invention may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

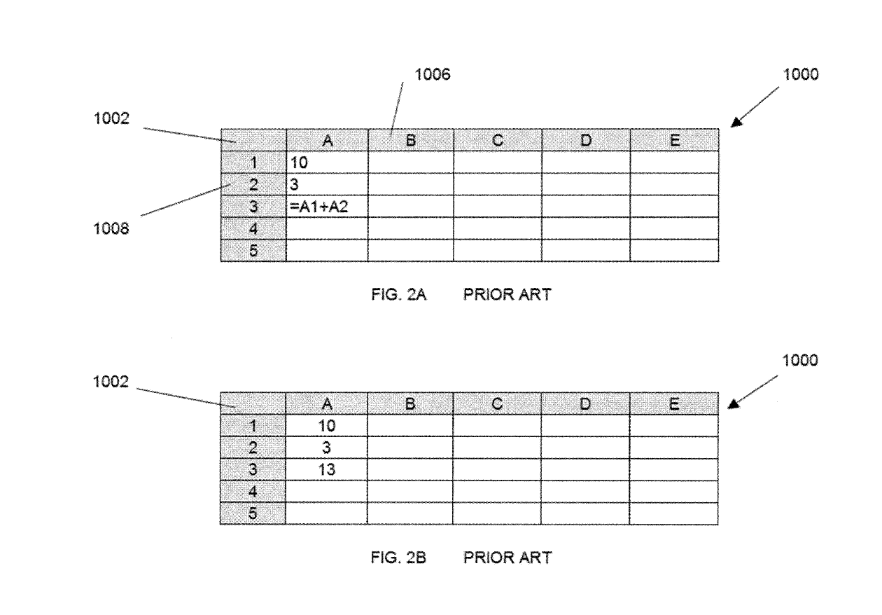

Aspects of a prior art spreadsheet application 1000 are shown in FIGS. 2A and 2B (collectively FIG. 2). The exemplary spreadsheet 1000 contains a table or matrix 1002. The table or matrix 1002 has five columns 1006, named A, B, C, D, and E, and five rows 1008 named 1, 2, 3, 4, and 5. A user may enter numbers, text, equations, and data in the cells of the exemplary spreadsheet 1000. Each cell is indicated by cell coordinates, which represent the intersection of a column and a row. For example, cell A1 is located at the intersection of column A and row 1.

In FIG. 2A, the contents of three cells, A1, A2, and A3 are shown. FIG. 2B illustrates how an exemplary prior art spreadsheet would display the contents in cells A1, A2, and A3. In other words, FIGS. 2A and 2B represent the same cells and spreadsheet. The difference is that FIG. 2A shows the contents of the cells while FIG. 2B shows the manner in which a user would see those cells displayed on a computer screen, such as display 22 of FIG. 1.

For example, referring to FIG. 2A, the cells A1 and A2 have as their contents the numbers 10 and 3 respectively. These numbers are the contents of those cells as shown in FIG. 2A. As such, they are displayed as those numbers in FIG. 2B.

As shown in FIG. 2A, the contents of cell A3 is the equation “=A1+A2”. This equation tells the spreadsheet application to add the contents of cells A1 and A2, which are the two cells referenced by the equation, and display that result in cell A3. As seen in FIG. 2B, the spreadsheet shows the result “13” in cell A3.

A basic feature of spreadsheets is the ability to reference or link different cells. In this example, call A3 references or links the contents of cells A1 and A2 by means of the equation “=A1+A2”.

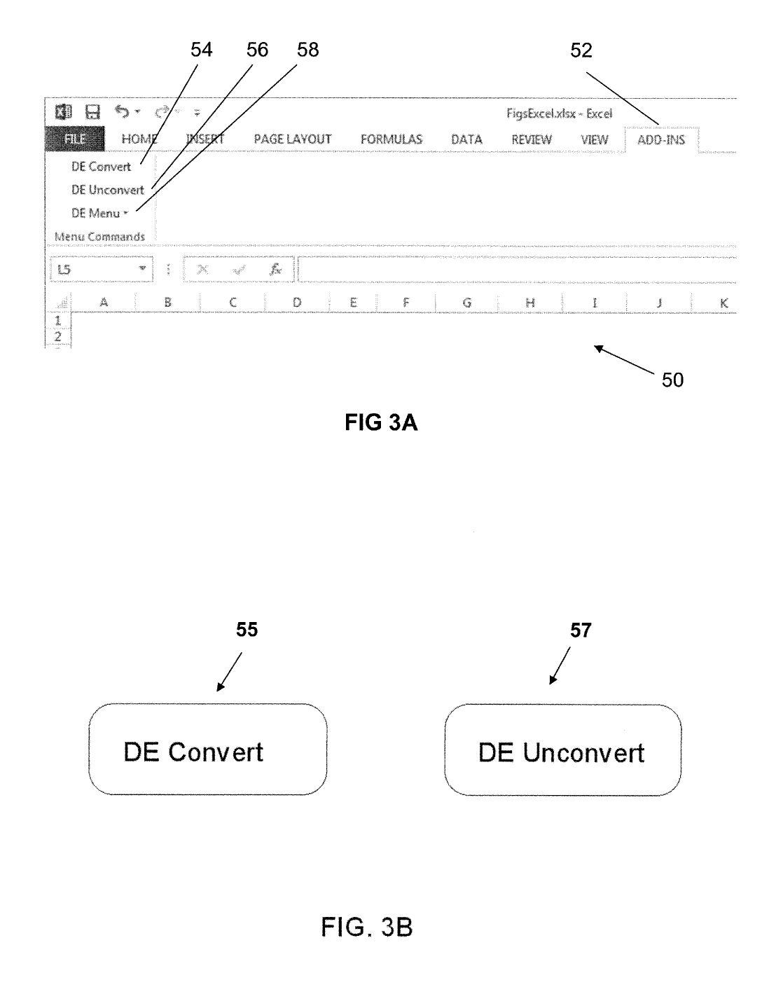

In addition to the matrix geography described in FIG. 2, the spreadsheet workbook application may also include various buttons and drop down menu commands to facilitate the present invention. In FIG. 3A, three menu commands are displayed in a screenshot 50 from an embodiment of an Addin program in accordance with the present invention operating within Microsoft Excel™. Under a tab “ADD-INS” 52, the menu commands are “DE Convert” 54, “DE Unconvert” 56, and a dropdown menu “DE Menu” 58 which operates in accordance with the present invention as discussed in further detail below. Alternatively, as illustrated in FIG. 3B, these commands may be displayed as icon buttons elsewhere within the spreadsheet workbook application. FIG. 3B shows icon buttons 55 and 57 for the “DE Convert” 52 and “DE Unconvert” 54 commands of the present invention. The user may position a cursor over these icon buttons, and indicate or activate them by depressing or clicking a mouse button. Alternatively, indications of either “DE Convert” or “DE Unconvert” could be entered by pressing a designated sequence of keys on the computer's keyboard.

A series of illustrative examples are provided that demonstrate the deficiencies of existing spreadsheet tools for manipulating dimensional quantities in formulas, as well as, the ease of use and performance of various aspects of the present invention.

One simple use of the present invention is to change a dimensional numerical quantity from one unit to another within a spreadsheet environment. Suppose it is desired to convert 10 inches to meters. The correct, converted answer is 0.254 meters. There are, of course, many ways to perform this conversion. For example, the Internet has many on-line unit converters that can perform this conversion.

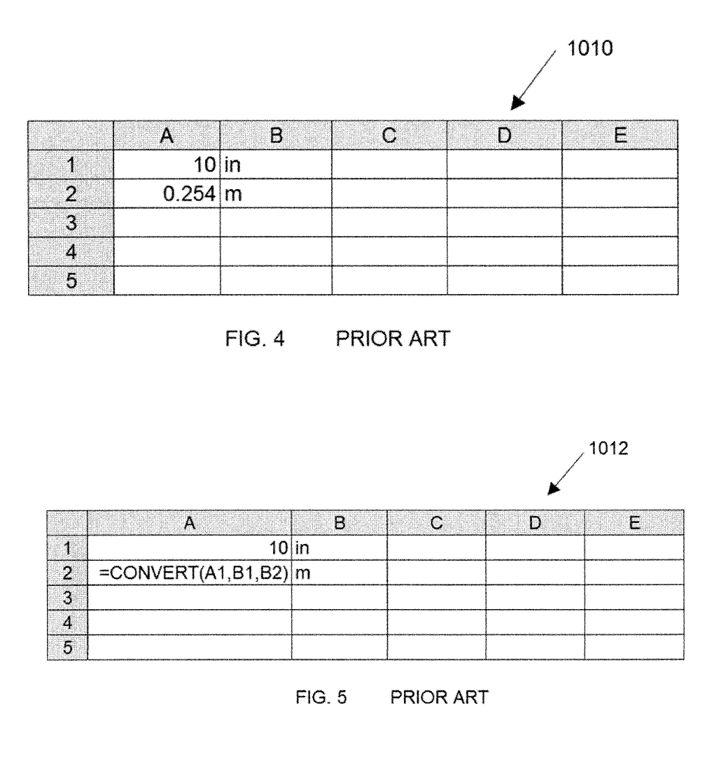

The present invention, however, is concerned with a spreadsheet environment in which numbers, text, and functions are entered into cells referenced by the intersection of row and column labels. One prior art approach to perform this conversion within a spreadsheet is to use one of the built-in conversion functions that come with most spreadsheets as illustrated in FIGS. 4 and 5; for example. FIG. 4 shows the output when converting 10 inches to meters in cells A1, B1, A2, and B2 using the standard Excel™ function “Convert”. In this example, there are three input cells in spreadsheet 1010. Cell A1 contains the number “10”. Cell B1 contains the dimensional unit of measure “in”. Together, cells A1 and B1 comprise a pair of cells with a dimensional quantity. In the example of FIG. 4, it is the input quantities 10 inches. Cell B2 contains the desired output dimension “m”, the standard indication for meters.

Although it is not obvious from spreadsheet 1010 in FIG. 4, the only cell that contains a formula is cell A2. This situation is made clear in FIG. 5 where the spreadsheet 1012 shows the contents of the same cells displayed in spreadsheet 1010 of FIG. 4. As shown by spreadsheet 1012, the contents of cell A2 is the formula “=CONVERT(A1, B1, B2)”. Hence, cell A2 has a formula or equation that references cells A1, B1, and B2.

There are several different ways in which the formula in cell A2 of spreadsheet 1012 can be entered into the spreadsheet. The formula could have been typed directly into the cell by the user, or the user may have used an “Insert Function” button inscribed with script “fx”, which would have allowed the user to choose the function (“Convert”) and then select the cell coordinates of the three arguments in individual entry windows.

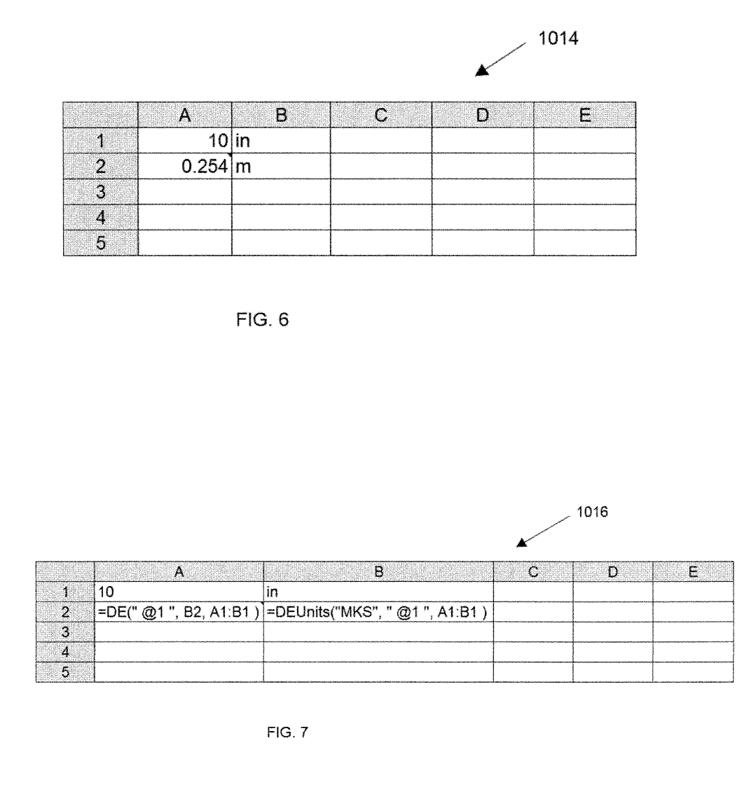

By contrast with the prior art approach illustrated by FIGS. 4 and 5, FIG. 6 shows a spreadsheet 1014 in which 10 inches has been converted to meters using the present invention. Naturally, the displayed results in spreadsheet 1014 of FIG. 6 are identical to the results shown for spreadsheet 1010 of FIG. 4. However, the contents 1016 shown in FIG. 7 for the two cells, cell A2 and cell B2, are different than those shown in spreadsheet 1012 of FIG. 5.

FIG. 7 shows spreadsheet cell contents 1016 in which the contents corresponding to the cells of the spreadsheet 1014 of FIG. 6 when an embodiment of the present invention is employed. Cell A2 contains the equation or formula “=DE(“@1”, B2, A1:B1)” while the cell B2 contains the equation or formula “=DEUnits(“MKS”, “@1”, A1:B1)”. The entries in the pair of input cells A1 and B1 for FIGS. 6 and 7 are identical to those in FIGS. 4 and 5, namely, the entry in cell A1 is the number ten, and the entry in cell B1 is the text string “in”.

Notice also that in the present example, cell A2 is linked to cells B2, A1, and B1, while cell B2 is linked to cells A1 and B1. Unlike the prior art, the invention automatically creates two sets of linked cells, one within the cell that will display the numerical value, cell A2, and another within the cell that will display the dimensional units, cell B2. This linkage of the invention is a more extensive set of links than occurs in the prior art and supports the improved functionality of the present invention. Further, cell A2 is referenced to cell B2, the other linked cell.

As with the prior art approach shown in FIGS. 4 and 5, the contents in cells A2 and B2 could have been entered by either typing the formulas directly or by clicking on the Insert Function button and then entering the arguments. However, an important component of the present invention allows the results obtained in FIGS. 4 and 5 to be entered in a way that cannot be used with existing spreadsheet functions such as Convert. The new approach of the present invention to setting up the spreadsheet calculations not only makes the physical task of entering, correcting, and managing the formula or calculation easier and less error prone, it also enables the spreadsheet to catch user errors and assist the user in correcting his or her calculations, as will be illustrated below.

Before describing the preferred method of entering dimensional formulas and calculations within a spreadsheet in accordance with the present invention, the interpretation of the formulas shown in cells A2 and B2 of spreadsheet 1016 in FIG. 7 is first discussed.

One of the principal advantages of existing spreadsheet programs is the vast range of mathematical functions available for manipulating numerical data. Most spreadsheets have functions for computing statistics such as averages, as well as tools for manipulating cells with text input. In addition, there are tools that make it easy to enter, edit, copy, paste, and manage formulas within spreadsheets. Users may also name cells, and then use those names in formulas. Users may also change the background and text colors within cells, which can be helpful for differentiating different kinds of cells, such as those with converted formulas, those with units, and so forth. A presently preferred embodiment of the present invention is adapted to utilizing and building upon these extensive features and advantages of spreadsheets for entering, editing, copying, pasting, and managing calculations involving dimensional data.

One of the limitations of existing spreadsheet tools, however, is that the spreadsheet must determine which input cells are referenced by different formulas in the spreadsheet so the spreadsheet can determine an acceptable order to in which to compute results. For example, for the simple formula “=A1+A2” shown in cell A3 in spreadsheet 1000 of FIG. 2B, the spreadsheet software must evaluate the contents of cells A1 and A2, the two cells referenced by the formula before it can determine the result to display in cell A3.

The same is true for calculations involving dimensional quantities, except in this case, the formula must reference both parts of the input pair of cells describing the dimensional quantity, the numerical value and the dimensional unit of measure. In other words, the present invention recognizes the need to set up two cells with their own linked reference cells in order to properly compute a dimensionally consistent result in a dimensional equation. Dimensional quantities require two parts, the numerical value and the dimensional units. To get both parts correct, and to be able to correctly identify when dimensional inconsistencies arise, both links are needed. The need for two separate links helps explain the syntax of the formulas in cells A2 and B2 in spreadsheet 1016. In cell A2, the function “DE” takes three arguments for this example. The first argument is a representation of a formula. In this simple case, the formula says to display the first argument, labeled “@1” and return that result in the cell. The second argument, B2, is a reference to a cell that may have requested output units for the dimensional output quantity. If cell B2 does have acceptable output units, then the output is reported in those units. If not, then default units are used. Finally, the third argument lists the pair of cells A1:B1 which define the first argument, labelled “@1”. In this manner, both cells in the input pair of cells are referenced in the argument list of the function DE, and changes to those inputs cause the appropriate update to the output in cell A2.

A similar syntax is used for the function “DEUnits” that appears in cell B2. In this case, the first argument, “MKS” gives the requested output units for the dimensional output, which appears in the pair of cells, A2 and B2. In this case, “MKS” is an indication to use the default units in the meter-kilogram-second system of measurements. For this particular example, the final output is in meters, so the first argument could have been “m” and the same results would have been displayed. The second argument is the formula that is the first argument of the function “DE”, which in this case is “@1”. Finally, the third argument for the function “DEUnits” is the pair of input cells, A1:B1.

The two function calls shown in cells A2 and B2 in spreadsheet 1016 of FIG. 7, correctly reference all the required input cells for the required computations. However, as is evident, even for this simple example, the formulas are lengthy and the syntax can be detailed and exacting. Manually inputting and managing formulas such as these can be cumbersome. Consequently, the present invention embodies a method for creating these formulas that is simple, easy to use, and takes advantage of existing formula manipulation tools available in spreadsheet applications.

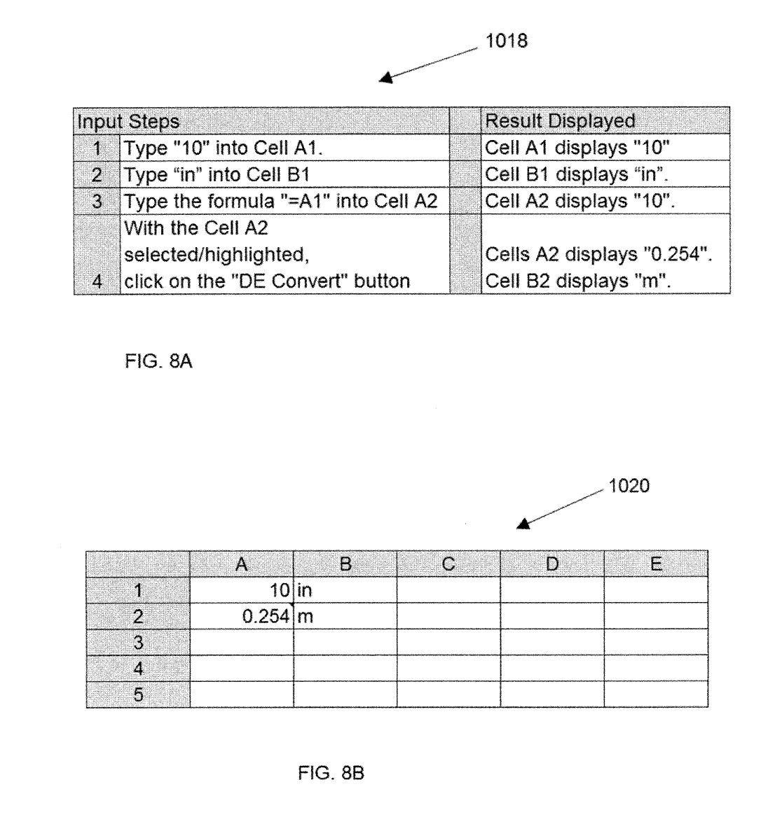

This easy-to-use functionality is illustrated by FIGS. 8A and 8B (collectively FIG. 8) which illustrate how the unit conversion shown in FIGS. 6 and 7 is set up in a spreadsheet application in accordance with the present invention.

FIG. 8A shows an instructions or input steps and resulting displayed output table 1018. There are four input steps. In the first step, the user types “10” into cell A1, after which cell A1 displays “10”. In the second step, the user types “in” into cell B1, after which cell B1 displays “in”. In the third step, the user types the formula “=A1” into cell A2. Notice that this formula only references cell A1, the numerical value of the dimensional quantity defined by the pair of cells, A1 and B1. Of course, since this is a standard formula in a spreadsheet, cell A2 displays “10”, which is the correct value of the function neglecting all the associated input dimensional units of measure. FIG. 8B shows the spreadsheet display 1020.

Notice, too, that when setting the original formula in cell A2, all the usual computational power of the spreadsheet application can be used, since any standard formula using standard cell inputs can be used. This initial formula is a standard spreadsheet formula that can be input by the user using any convenient method. Spreadsheets typically have several different methods of inputting formulas into a cell, and the user can use whichever method he or she prefers.

Finally, in step 4, a conversion step is performed that produces the final result. The user highlights or selects cell A2, which has the formula only involving the numeric values of any dimensional input quantities, and with that cell highlighted or selected, the user clicks or depresses an indicator such as the “DE Convert” selector 54 or button 55, illustrated in FIGS. 3A and 3B, respectively.

This clicking is an indication to perform “DE Convert” processing. With cell A2 selected, the pair of cells, A2 and B2 is altered so that the original formula, “=A1” altered, and the pair of cells A2 and B2 then have calls to the functions “DE” and “DEUnits”, with all the appropriate referencing and linking cells. Note that cell B2 does not need to be highlighted or selected when the “DE Convert” button is pressed. The ability to create this complex, linked set of spreadsheet cell formulas with a simple click on a single cell is one of the most powerful and novel aspects of the present invention. In particular, the original formula in cell A2 is parsed into a different symbolic form, substituting references to cells in the formula to different labels, “@1” in this case. The corresponding pairs of cells comprising the dimensional quantity typically reside in adjacent cells, with the numeric value in the left cell and the dimensional unit of measure in the right cell. Hence, as embodied here, the reference to cell A1 in the original formula is interpreted to mean that the numeric value is in cell A1 and the dimensional unit of measure is in cell B1. There are alternative methods to implicitly define or link pairs of cells for dimensional quantities in a spreadsheet application, but the above approach is a particularly straightforward and easy to understand one. In addition to assuming that all dimensional input quantities are in adjacent pairs of cells, the present embodiment also preestablishes that the output will also reside in a pair of adjacent cells, the numerical value to be displayed in the cell with the original formula, and the dimensional units of measure in the cell immediately to the right of that cell.

Consequently, when “DE Convert” is indicated, the contents of the cell immediately to the right of the selected cell with the original formula, cell B2 in this example, is examined. If the cell contains a valid dimensional unit of measure for the output, then that is listed as the first argument in the call to “DEUnits”. If this cell is empty, then a default set of output dimensional units of measure are used. In this example, since the cell was empty, the default MKS system was used, resulting in the output being listed in meters. Finally, to ensure that all the input cell pairs are included as references in these function calls, these cells are listed in the argument lists, both to indicate the proper substitutions for the labels and also to ensure that the spreadsheet correctly updates changes to these cells. Thus, the linking and referencing required by the invention is established to support proper evaluation of the dimensional formulas.

With a presently preferred entry method having been described in connection with the input instruction table 1018 shown in FIG. 8A, the user does not have to do more than input the dimensional quantities and then construct a valid spreadsheet formula involving just the numeric values of the input dimensional quantities. Entering a formula in a spreadsheet that involves just numeric values is easy, and spreadsheets have many features to help users accomplish this entry. Then, with a mouse click, such as a mouse click of mouse 16 of FIG. 1, both cells in the pair of output dimensional cells are appropriately updated and displayed in a spreadsheet displayed on a display, such as display 22, for example. This approach is easy and involves less typing than a typical prior art approach. There are no issues with misspellings, typos, or syntax using the inventive approach. The original formula is a standard spreadsheet formula. The linking of cells, no matter how complicated, is properly created.

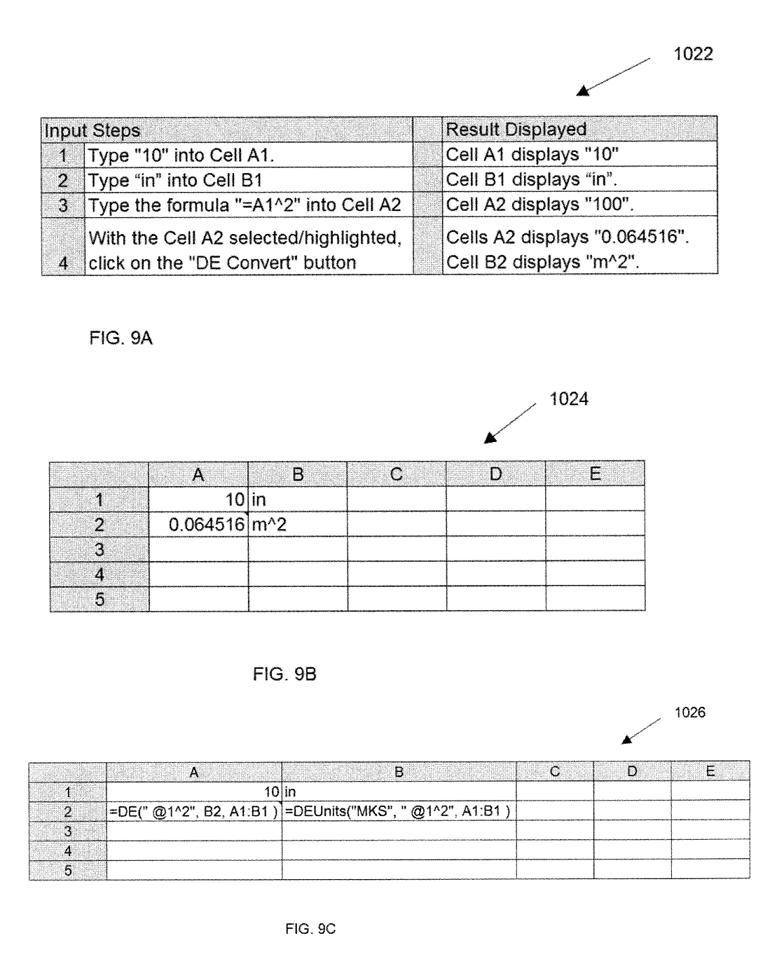

Next, suppose it is desired to compute the area of a 10 inch by 10 inch square. FIG. 9 shows a table of steps 1022 required to enter this calculation in FIG. 9A, the resulting displayed output screen 1024 in FIG. 9B, and the final contents of the cells 1026 in FIG. 9C.

For the present invention, the steps to compute the area of a 10 inch by 10 inch square are listed in table 1022. First the user types “10” into cell A1. Cell A1 then displays the number “10”. Next, the user types “in” into cell B1. Cell B1 then displays “in”. Next, the user types the formula “=A1̂2” into cell A2. This formula, involving references only to cells with numerical values, can be input using any of the methods supported by the spreadsheet. Naturally, following the rules of standard spreadsheets, cell A2 shows the number “100” which is the product of ten times ten. Finally, with cell A2 selected or highlighted, the user clicks on the “DE Convert” button. Cell B2 does not need to be highlighted or selected. Since we have left the cell B2, the cell that will have the output dimensional units of measure, empty, the dimensional calculation will use the default MKS units, so the final results will be reported in units of square meters, “m̂2”. As shown in 1024 in FIG. 9B, and as listed in the final result of 1022, after converting the original formula, cell A2 shows “0.064516” and cell B2 shows “m̂2”, which is the correct conversion of 100 square inches into meters.

Although cell B2 was empty before clicking on “DE Convert”, afterwards, it contains a formula linking it to cells A1 and B1. The “DE Convert” indication creates additional important cell referencing in the spreadsheet.

As shown in FIG. 9C, the corresponding contents of cells A2 and B2 after the conversion, are functions of “DE” and “DEUnits”. In this case, the label “@1” still refers to the input pair of cells A1 and B1, but the formula to parse is “@1̂2”. Since the spreadsheet formula knows that the formula squares the input dimensions, it knows that the output dimensions should be in units of length squared.

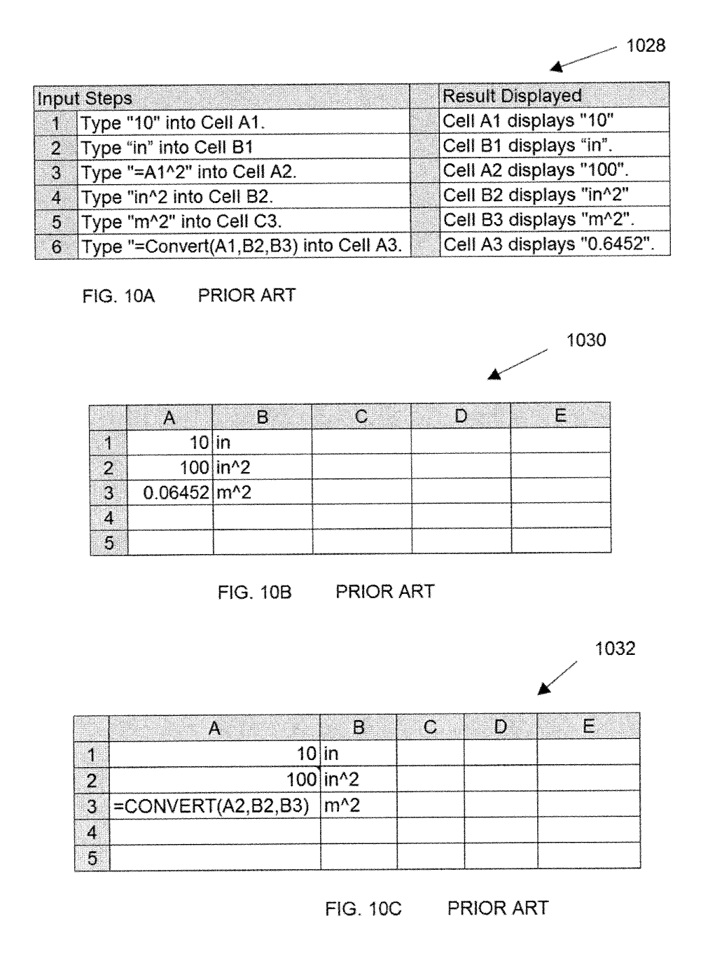

This example shows that present invention can perform standard spreadsheet calculations while simultaneously performing the necessary unit conversions. The limitations and difficulties of performing this same computation using the prior art spreadsheet function “Convert” are shown in FIGS. 10A-10C (collectively FIG. 10) which illustrate one prior art approach. A table of steps 1028 required of the user is shown in FIG. 10A. The resulting output display 1030 is shown in FIG. 10B, and the final contents 1032 of the spreadsheet cells are shown in FIG. 10C.

To compute 10 inches squared using Convert, the user types “10” into cell A1, which then displays “10”. Next, the user types “in” into cell B1, which displays “in”. Then, in cell A2, the user should enter the formula “=A1̂2”, which then displays “100”. So far, this sequence of steps is identical to the present invention. However, at this point, additional work must be done by the user to use the “Convert” function. Namely, the user must type “in̂2” into cell B2, which displays “in̂2”. Next, the user must type “m̂2” into cell C3, which displays, “m̂2”. Finally, the user must enter the Convert function “=Convert(A1, B2, B3)” into cell A3. As can be seen in 1030, with these entries, the correct answer is obtained, but to reach this result, more typing is required and there is much more opportunity for a mistake or mistakes. Most problematically, although the mathematical formulas for the numbers involved in the calculation can be used as expected, there is no corresponding function to recognize that when inches (Cell B1) are squared (the formula in the first argument of Cell A3), the result is inches squared (Cell B2). In fact, the entry “in” in Cell B1 is not needed above to perform the calculation, even though it is intrinsic to the problem. The prior art approach illustrated in FIG. 10 fails to connect the input units (Cell B1) to the conversion formula (Cell A3). In other words, the illustrated prior art approach does not automatically check for consistency in any dimensional computations.

Notice also that when using the prior art approach, there is only one linked cell, cell A3. All the other cells in this example contain either a numeric value or a dimensional unit. There are no other cell references. This lack of referencing is one of the reasons the prior art approach cannot determine is the results of a dimensional formula is dimensionally consistent.

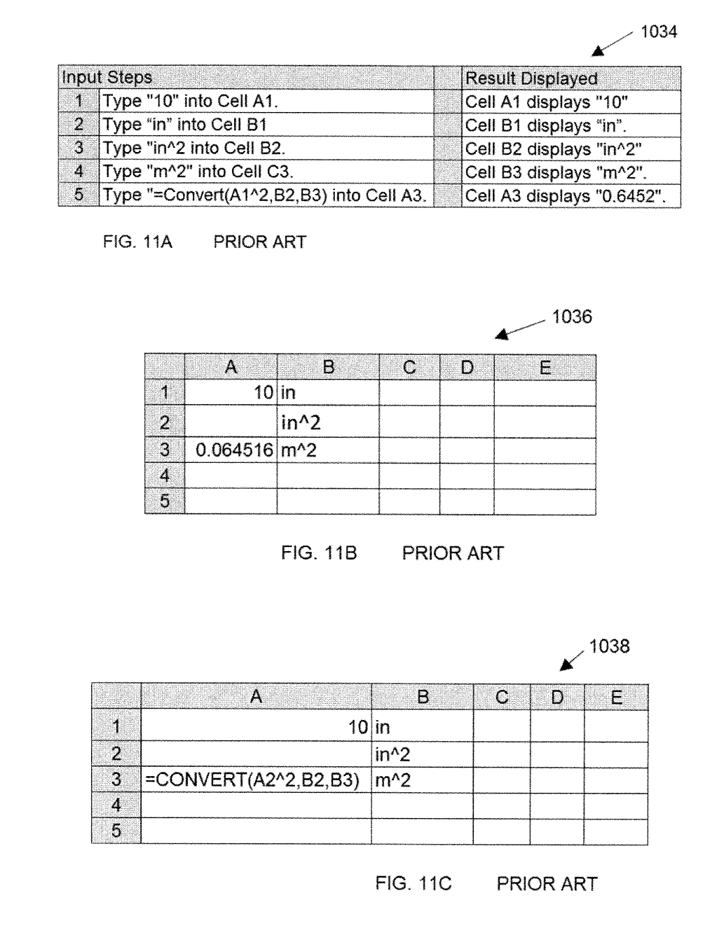

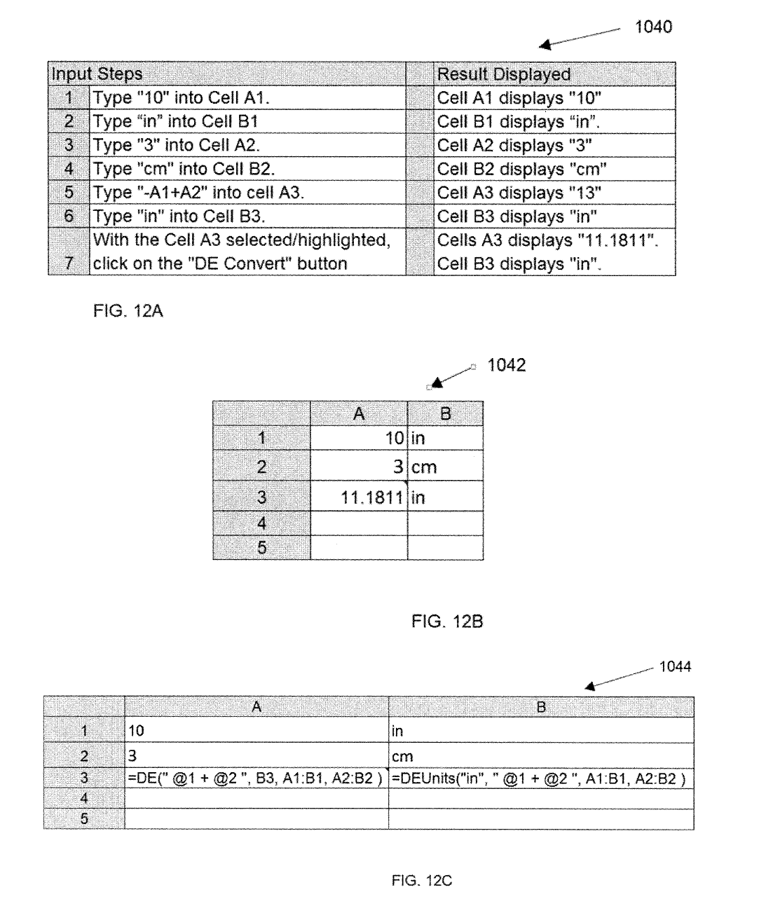

Even if one embeds the equation into the first argument of the “Convert” function, these problems remain. FIGS. 11A-11C (collectively FIG. 11) illustrate an alternative prior art approach to solving the same problem solved the standard spreadsheet function “Convert”. In this case, the original formula, ̂2″ is embedded as an argument of the Convert function. This approach is shown in the input steps table 1034 of FIG. 11A. Of course, the resulting output display 1036 shown in FIG. 11B is identical. However, it is the user who must know and correctly enter the correct input units (“in̂2” in cell B2) and output units (“m̂2” in cell B3). Again, using the prior art approach, only one cell is created which links or references the other cells in the spreadsheet. In this example, cell A3 links to cells A2, B2, and B3.

As a next example, the addition of 10 inches and 3 centimeters and display of the final result in inches is considered. In this case, the mathematical formula for addition is used, and it is necessary to insure that the input units associated with each input are utilized as part of the addition in a dimensionally correct and consistent manner. It is further necessary to indicate that the final output should be in inches. How this example is addressed utilizing the present invention is illustrated in FIGS. 12A-12C (collectively FIG. 12). The user steps and displayed output table 1040 is shown in FIG. 12A. The final displayed output 1042 is shown in FIG. 12B. The final contents 1044 of the cells are shown in FIG. 12C.

As shown in table 1040, the user must type “10” into cell A1, which shows “10”. Next, the user must type “in” into cell B1, which displays “in”. Next, the user types “3” into cell A2, which shows “3”. Then the user types “cm” into cell B2, which shows “cm”. Then, the user enters the formula “=A1+A2” into cell A3. This formula takes as input only the numeric values of two pairs of dimensional input quantities that reside in the pairs of cells A1 and B1 and A2 and B2. The formula does not have any reference to the dimensional units of measures that are located in cells B1 and B2. As a result, the formula initially displays the sum “13”, which is ten plus three.

To complete the output part of the problem, the user inputs the desired output dimensional units of measure, “in”, into cell B3. This will be the second of the pair of output cells, A3 and B3. Finally, with cell A3 selected or highlighted, the user clicks on “DE Convert”. Cell B3 does not need to be highlighted or selected. This conversion replaces the contents of the output pair of cells A3 and B3 with the calls to functions “DE” and “DEUnits”, as shown in 1044. In this case, the argument list for each of these functions has four arguments because there are two cell references in the original input formula, which have been replaced by the labels “@1” and “@2” in the formula that appears in the argument list. The final output of 11.1811 inches, displayed in cells A3 and B3, is shown in 1042.

Note that in accordance with one aspect of the present embodiment of the invention, the user can easily change the input dimensional quantities and the spreadsheet will update the output dimensional quantities automatically. For example, to add 10 inches to 3 miles, one would take the spreadsheet shown in FIG. 12 and change the contents of cell B2 to “miles”. The output answer is then “190090” inches.

Notice again that the indication of pressing the “DE Convert” button causes two cells to be populated with reference cells prior to pressing “DE Convert”.

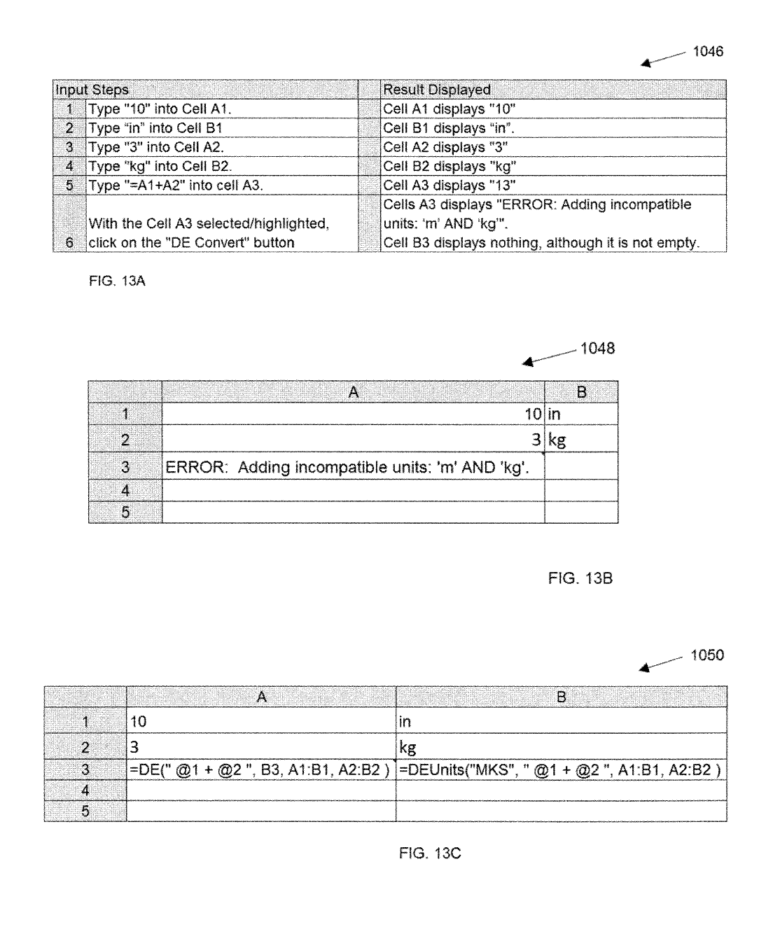

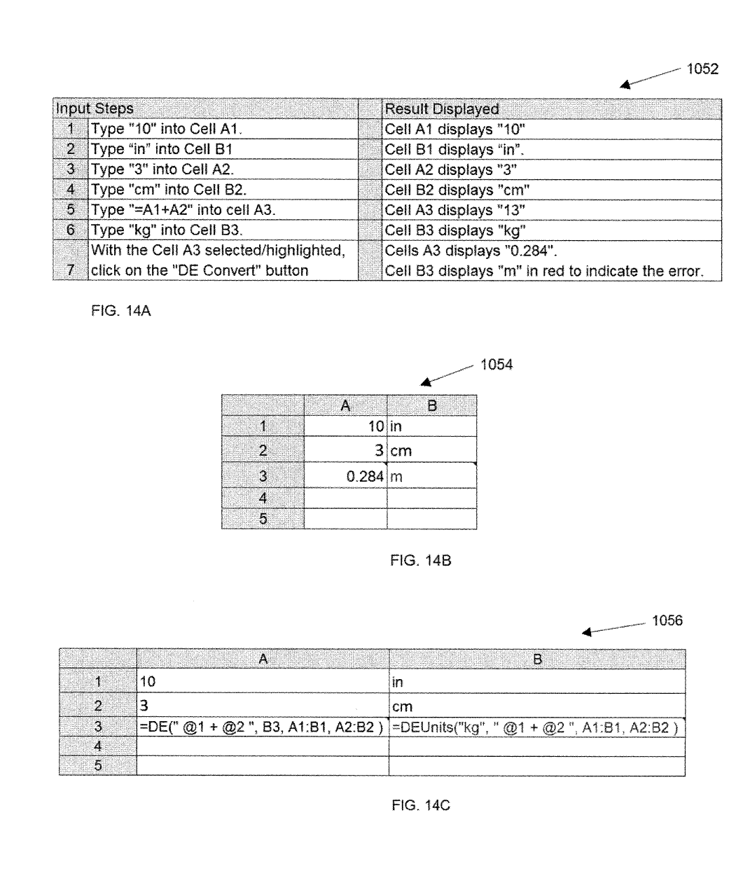

Even with the present invention, the user can make mistakes in making a spreadsheet input. However, with the present invention, useful error messages are returned. Suppose a user tries to add 10 inches to 3 kilograms. Of course this attempted addition is dimensionally inconsistent and nonsensical. The present invention catches this error, as shown in FIGS. 13A-13C (collectively FIG. 13). The user steps and displayed output table 1046 is shown in FIG. 13A. The final displayed output display 1048 is shown in FIG. 13B. The final contents 1050 of the cells are shown in FIG. 13C.

As shown in table 1046, the user must type “10” into cell A1, which shows “10”. Next, the user must type “in” into cell B1, which displays “in”. Next, the user types “3” into cell A2, which shows “3”. Then the user types “kg” into cell B2, which shows “kg”. Then, the user enters the formula “=A1+A2” into cell A3. The formula, which originally only includes references to the numeric values of the input dimensional quantities, initially displays the sum “13”, which is ten plus three.

Finally, with cell A3 selected or highlighted, the user clicks on “DE Convert”. Cell B3 does not need to be highlighted or selected. This replaces the contents of the output pair of cells A3 and B3 with the calls to functions “DE” and “DEUnits”, as shown in contents 1050. Cells A3 and B3 comprise the new pair of cells with linked formulas. In this case, when these two functions are parsed and computed, the dimensional formula adding the pairs of cells A1 and B1 to A2 and B2, the inconsistency in the units is detected, and an error message, such as “ERROR: Adding incompatible units: ‘m’ AND ‘kg’” is shown in cell A3 of contents 1050. Cell B3, which contains a call to “DEUnits”, displays nothing. It is possible to properly determine an inconsistency and then output meaningful error messages because of the linking in the pair of cells caused by the “DE Convert” button.

Now suppose a different kind of error occurs. More particularly, suppose an attempt is made to add 10 inches to 3 centimeters but an output in kilograms is requested. The addition is dimensionally consistent, so there is an answer to the calculation, but the requested output units are not possible or consistent. The present invention also catches this error, displays the dimensionally correct answer using red units so that the user is aware that his or her requested units are not consistent.

The present invention catches this error, as shown in FIGS. 14A-14C (collectively FIG. 14). The user steps and displayed output table 1052 is shown in FIG. 14A. The final displayed output 1054 is shown in FIG. 14B. The final contents 1056 of the cells are shown in FIG. 14C.

As shown in table 1052, the user must type “10” into cell A1, which shows “10”. Next, the user must type “in” into cell B1, which displays “in”. Next, the user types “3” into cell A2, which shows “3”. Then, the user types “cm” into cell B2, which shows “cm”. Next, the user enters the formula “=A1+A2” into cell A3. The formula, which originally only includes references to the numeric values of the input dimensional quantities, initially displays the sum “13”, which is ten plus three. Next, the user types “kg” into cell B3 which displays “kg”.

Finally, with cell A3 selected or highlighted, the user clicks on “DE Convert”. Cell B3 does not need to be highlighted or selected. This replaces the contents of the output pair of cells A3 and B3 with the calls to functions “DE” and “DEUnits”, as shown in 1056. In this case, when these two functions parse and compute the dimensional formula adding the pairs of cells A1 and B1 to A2 and B2, the inconsistency in the requested output units is detected. In the current embodiment of the invention, the correct and dimensionally consistent output to the equation is displayed in the pair of output cells, A3 and B3, using default units, which in this case are meters, “m”. The correct answer is 0.284 meters, as shown in 1054. However, the units shown in cell B3 are displayed in red to indicate that there was a problem with the requested output units, “kg”. Notice as well, in the contents of the cells, 1056, that the original requested output units, “kg” are listed as the first argument in the call to “DEUnits”.

This example illustrates another important feature of the present invention. An erroneous request for an output in kilograms was made, which made no sense. A red dimensionally consistent answer in meters was obtained and displayed. However, having realized the error, in many cases the user will want to edit the mistakes and request the answer in a different, dimensionally correct unit. For example, having seen that the answer is a length, suppose the user wanted the answer in yards rather than meters.

The spreadsheet cells need to be edited to make this change. There are at least two possible approaches. If the user is comfortable with the DEUnits function syntax, he or she could edit the formula in cell B3 and change the first argument from “kg” to “yards”. While this approach works, it requires both expertise with the function calls and careful typing. An aspect of the present invention provides a method to edit the equation that requires both little expertise and typing.

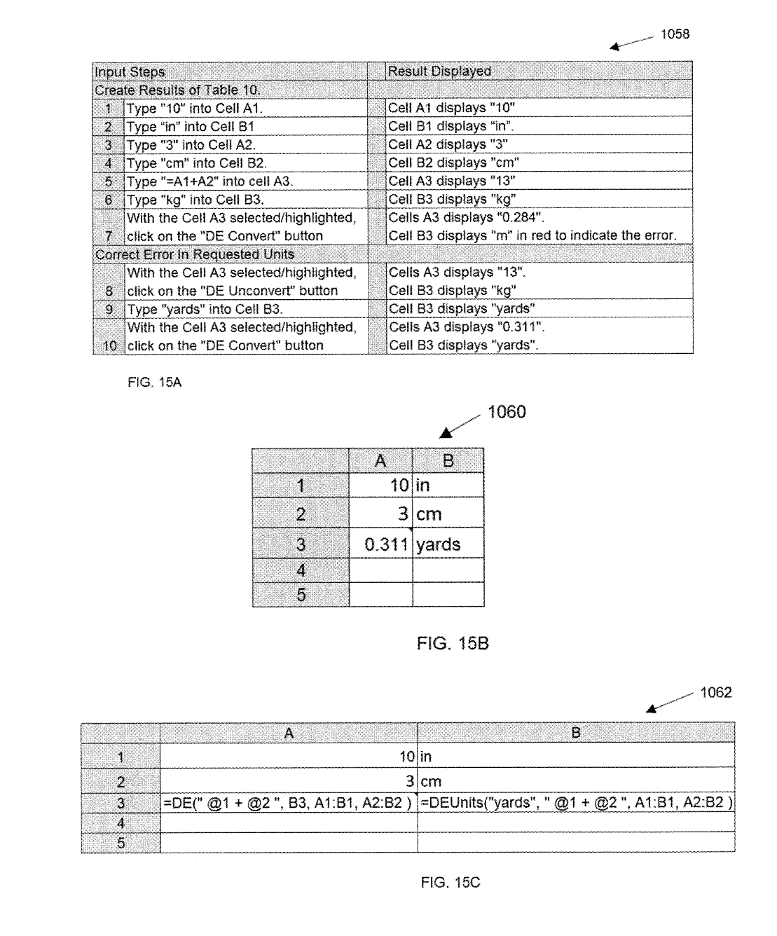

The present invention catches the original error, as shown in FIG. 14 above. The required user steps and displayed output to fix the error are shown in table 1058 of FIG. 15A. The final displayed output 1060 is shown in FIG. 15B. The final contents 1062 of the cells are shown in FIG. 15C.

As shown in table 1058, the mistake illustrated in FIG. 14 is first replicated. The user types “10” into cell A1, which shows “10”. Next, the user types “in” into cell B1, which displays “in”. Next, the user types “3” into cell A2, which shows “3”. Then, the user types “cm” into cell B2, which shows “cm”. Then, the user enters the formula “=A1+A2” into cell A3. The formula, which originally only includes references to the numeric values of the input dimensional quantities, initially displays the sum “13”, which is ten plus three. Next, the user types “kg” into cell B3 which displays “kg”.

Finally, with cell A3 selected or highlighted, the user clicks on “DE Convert”. Cell B3 does not need to be highlighted or selected. This replicates the results of FIG. 14. To correct this, the user again selects the cell A3 and clicks on the button “DE Unconvert” 57. When this happens, the original contents of cells A3 and B3 are restored. That is, the contents of cell A3 becomes the equation “=A1+A2” and the contents of cell B3 becomes the requested units “kg”.

The advantage of the “DE Unconvert” button is that it restores the original contents of the output pair of cells. The original contents of this pair of cells is easy to edit using the standard tools available in a spreadsheet. In this example, the user wants to change the requested output units from “kg” to “yards”, so the contents of cell B3 are overwritten or changed from “kg” to “yards”. Then, with cell A3 selected, the “DE Convert” button is again clicked on to update the output pair of cells A3 and B3 to contain calls to the functions “DE” and “DEUnits”. As shown in the displayed output 1060, the correct answer, 0.311 yards, is displayed.

The reversibility of the “DE Convert” and “DE Unconvert” buttons makes it easy to use the standard editing tools for the spreadsheet to input, edit, correct, and manage dimensional computations within a spreadsheet. This ease of use is an important advantage of the present embodiment of the invention. This ability is only possible as a result of the proper cell linking in both cells.

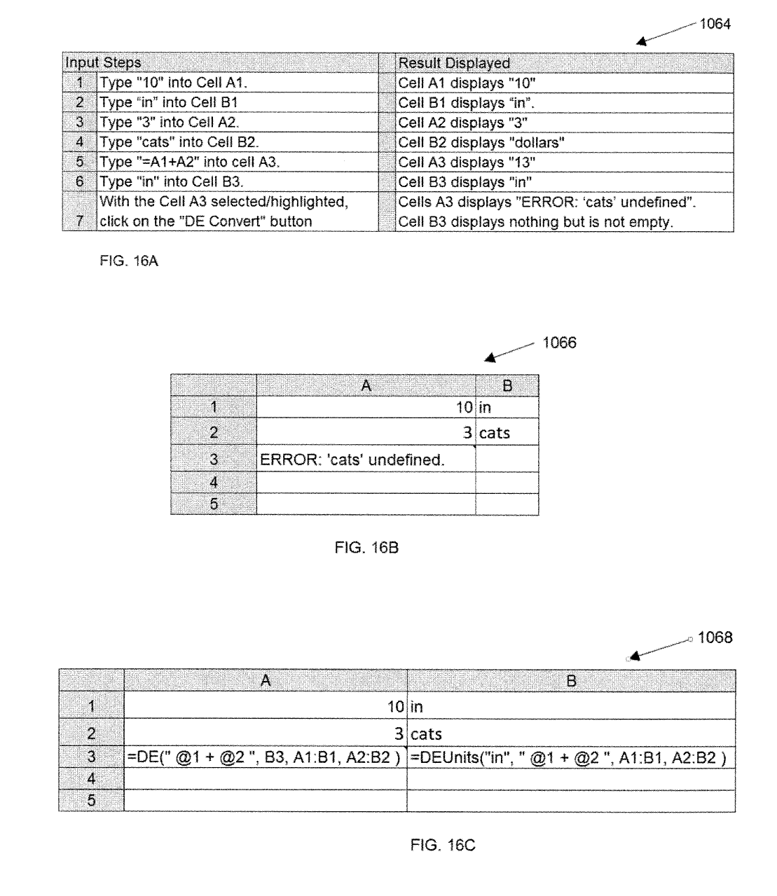

Of course, sometimes the user will either use or request units that the invention does not recognize, either because they are relatively uncommon units or because the units do not exist. An example of this is type of error is shown in FIGS. 16A-16C (collectively FIG. 16).

The user steps and displayed output table 1064 is shown in FIG. 16A. The final displayed output 1066 is shown in FIG. 16B. The final contents 1068 of the cells are shown in FIG. 16C.

As shown in table 1064, the user first types “10” into cell A1, which shows “10”. Next, the user types “in” into cell B1, which displays “in”. Next, the user types “3” into cell A2, which shows “3”. Then the user types “cats” into cell B2, which shows “cats”. Although the present invention can be designed to recognize many different units, the present invention is not programmed to recognize cats as a valid unit. As another example, rather than typing “in”, the user mistypes “ib” or “im” or some other common typographical error.

Continuing with the “cats” example, the user then enters the formula “=A1+A2” into cell A3. The user can also type “in” into cell B3 to request the output in inches. Finally, with cell A3 selected or highlighted, the user clicks on “DE Convert”. Cell B3 does not need to be highlighted or selected. In this example, as shown in 1066, the displayed output in cell A3 is “ERROR: ‘cats’ undefined.” Although cell B3 has a call to DEUnits, it displays nothing.

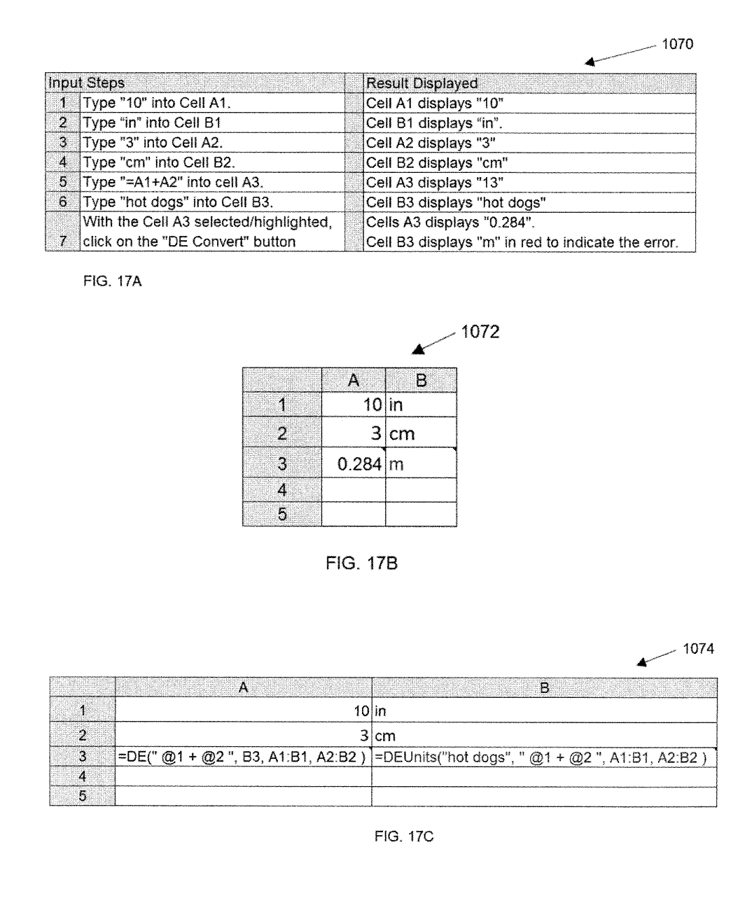

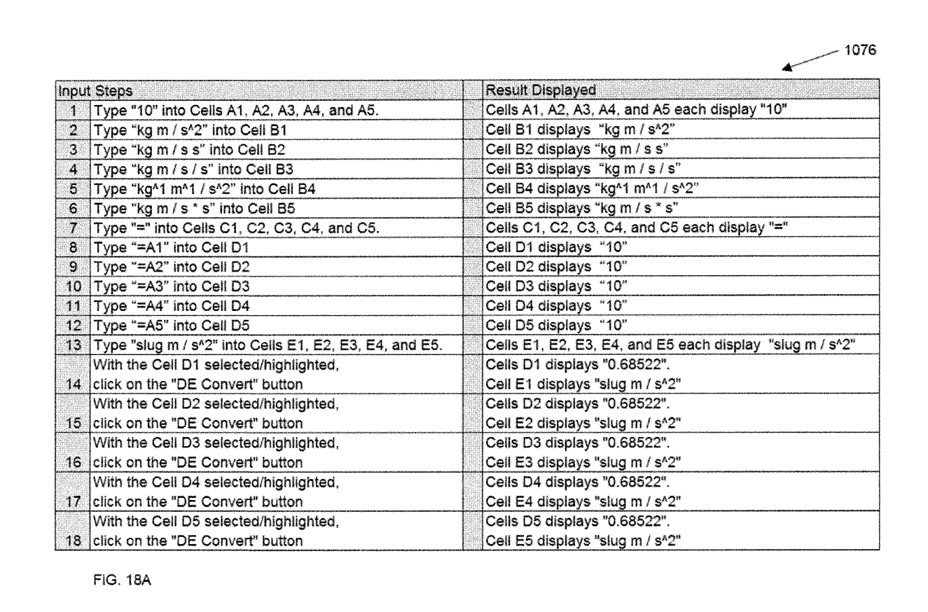

Similarly, FIGS. 17A-17C (collectively FIG. 17) illustrate what happens if the user requests output units that are not recognized. In many respects, this example is similar to that shown in FIG. 14 in that the requested calculation has a valid output but the dimensional units of measure requested for the output do not match the valid output.

The user steps and displayed output table 1070 are shown in FIG. 17A. The final displayed output 1072 is shown in FIG. 17B. The final contents 1074 of the cells are shown in FIG. 17C.

As shown in table 1070, the user first types “10” into cell A1, which shows “10”. Next, the user types “in” into cell B1, which displays “in”. Next, the user types “3” into cell A2, which shows “3”. Then the user types “cm” into cell B2, which shows “cm”. Then, the user enters the formula “=A1+A2” into cell A3. Then, the user types “hot dogs” into cell B3 to request the output in “hot dogs”. This, of course, is not consistent with the input. Finally, with cell A3 selected or highlighted, the user clicks on “DE Convert”. Cell B3 does not need to be highlighted or selected. In this example, as shown in 1072, the displayed output in cell A3 is 0.284 meters, but the meters “m” is displayed in red to indicate that the requested output could not be converted to “hot dogs”.

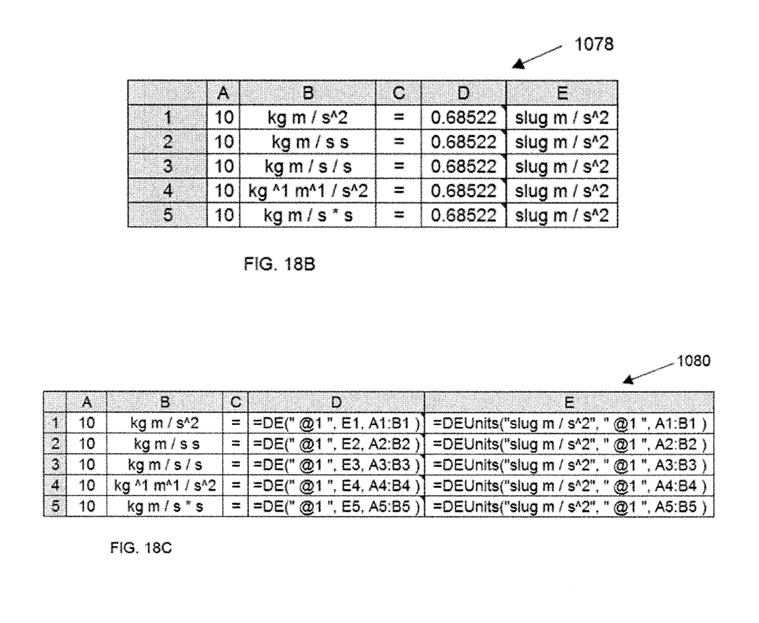

A further aspect of the current embodiment of the present invention allows units to be expressed as simple combinations of units expressed with a flexible syntax. For example, this invention interprets “kgm/ŝ2”, “kgm/s s”, “kgm/s/s”, “kĝ1 m̂1 ŝ3”, and “kgm/s*s” as equivalent units for force, and can be converted to “slug m/ŝ2”, even though it combines metric and English units. This flexibility is illustrated in FIGS. 18A-18C (collectively FIG. 18). The required user steps and displayed output table 1076 is shown in FIG. 18A. The final displayed output 1078 is shown in FIG. 18B. The final contents 1080 of the cells are shown in FIG. 18C.

As shown in table 1076, the user first types “10” into cells A1, A2, A3, A4, and A5. These cells display “10”. Next, the user types “kgm/ŝ2” into cell B1; “kgm/s s” into cell B2; “kgm/s/s” into cell B3; “kĝ1 m̂1/ŝ2” into cell B4; and “kgm/s*s” into cell B5. These are each displayed as they are typed. Next the formulas “=A1” is typed into Cell D1, “=A2” is typed into Cell D2, “=A3” is typed into Cell D3, “=A4” is typed into Cell D4, and “=A5” is typed into Cell D5. None of these formulas involve the dimensional units of measure of the input pairs of cells, so the output in all the cells is “10”. Finally, the user types “slug m/ŝ2” into cells E1, E2, E3, E4, and E5, which displays these output units of measure.

To perform the requested conversions, the user selects or highlights cell D1, then clicks on “DE Convert”. Cell E1 does not need to be highlighted or selected. Next, the user selects or highlights cell D2, then clicks on “DE Convert”. Cell E2 does not need to be highlighted or selected. Next, the user selects or highlights cell D3, the clicks on “DE Convert”. Cell E3 does not need to be highlighted or selected. Next, the user selects or highlights cell D4, then clicks on “DE Convert”. Cell E4 does not need to be highlighted or selected. Next, the user selects or highlights cell D5, then clicks on “DE Convert”. Cell E5 does not need to be highlighted or selected. The result is the same in all cases: the pairs of cells D1 and E1, D2 and E2, D3 and E3, D4 and E4, and D5 and E5, all display 0.68522 slug m/ŝ2.

Alternatively, the present invention has been designed so that multiple cells can be converted in a single click on “DE Convert”. So, in the present example, the user would select cells D1, D2, D3, D4, and D5 at the same time, and then click on “DE Convert”. The result is the same.

An embodiment of the present invention has been programmed to recognize a wide range of units. This range includes common abbreviations such as “mph” for miles per hour, four different temperatures (“degK” for degrees Kelvin, “degC” for degrees Celsius, “degF” for degrees Fahrenheit, and “degR” for degrees Rankine), as well as four corresponding units for temperature differences (“degKdiff”, “degCdiff”, “degFdiff”, and “degRdiff”), which convert differently than temperature do since they represent relative temperatures rather than absolute temperatures.

This embodiment of the present invention has been programmed to use four common default unit systems whenever the output units are not explicitly requested or whenever the explicitly requested output units are not dimensionally consistent with the output. These are MKS, for meter-kilogram-second, cgs for centimeter-gram-second, FPS for foot-pound-second, and IPS for inch-pound-second. The pound in IPS and FPS is lbf, not lbm.

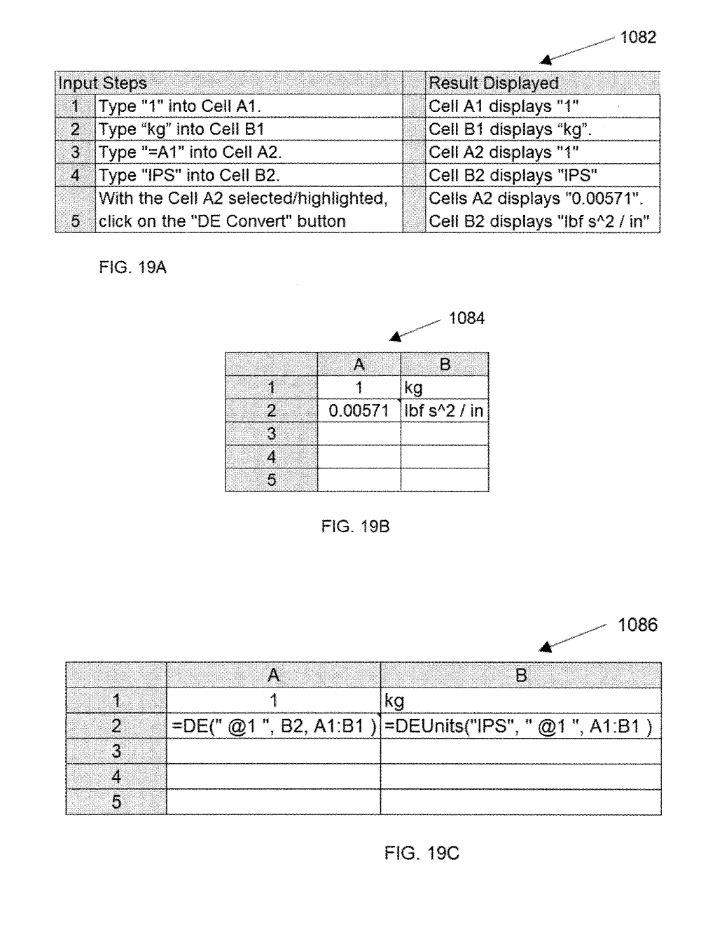

FIGS. 19A-19C (collectively FIG. 19) illustrate the use of default units. In this example, one kilogram is converted to IPS units. The required user steps and displayed output table 1082 is shown in FIG. 19A. The final displayed output 1084 is shown in FIG. 19B. The final contents 1086 of the cells are shown in FIG. 19C.

As shown in table 1082, the user first types “1” into cell A1, which shows “1”. Next, the user types “kg” into cell B1, which displays “kg”. Next, the user types “=A1” into cell A2, which shows “1”. Then the user types “IPS” into cell B2, which shows “IPS”. Then, with cell A2 selected or highlighted, the user clicks on “DE Convert”. Cell B2 does not need to be highlighted or selected. The displayed output 1084 shows that one kilogram is equivalent to 0.00571 lbf ŝ2/in.

One of the great advantages of the present invention is that it correctly uses the dimensional output of previous spreadsheet calculations in other cells in subsequent calculations, even when the units are in different combinations of metric and English units. Traditional spreadsheet functions like sine, cosine, log, sqrt, and so forth can also be used in the dimensional calculations. For example, the spreadsheet “Solver” function can be used to find either roots or minima or maxima of functions.

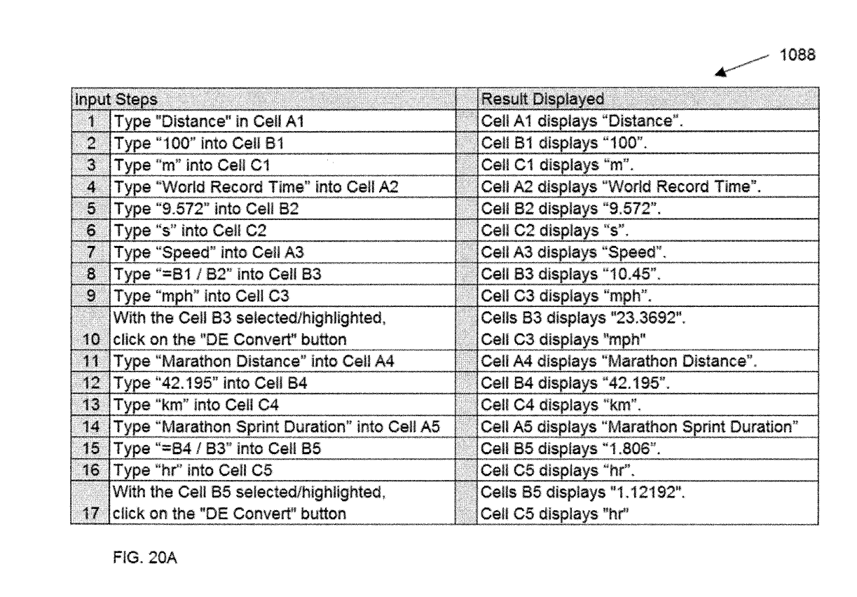

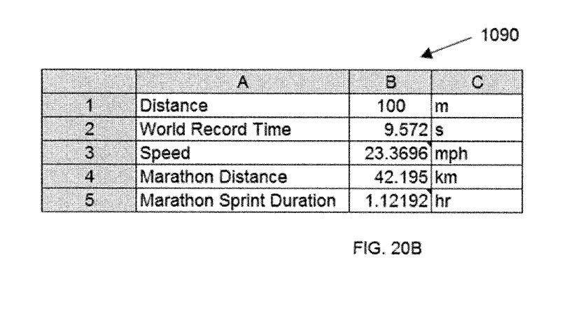

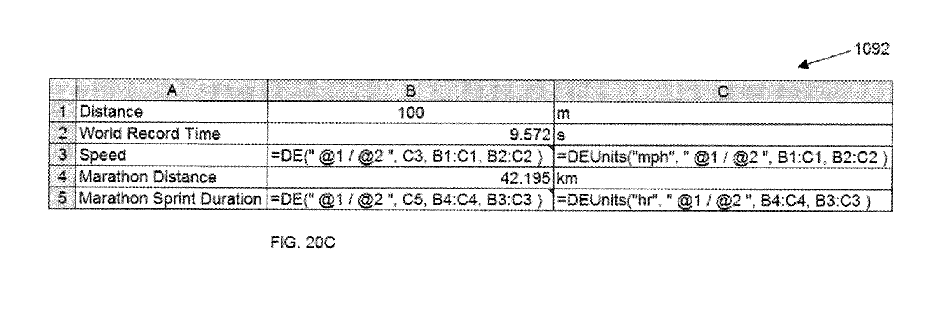

FIGS. 20A-20C (collectively FIG. 20) illustrate an exemplary calculation that involves repeated use of dimensional quantities in formulas. The required user steps and displayed output table 1088 is shown in FIG. 20A. The final displayed output 1090 is shown in FIG. 20B. The final contents 1092 of the cells are shown in FIG. 20C. In this particular example, an additional column is added labeling each of the rows. This labeling aids the readability of the final output.

As shown in table 1088, the user types “Distance” in cell A1 which displays “Distance”. Next, the user types “100” into cell B1 which displays “100”. Next, the user types “m” into cell C1, which displays “m”. This input represents 100 meters. Next, the user types “World Record Time” into cell A2, which displays “World Record Time”. Next, the user types “9.572” into cell B2, which displays “9.572”. Then, the user types “s” into cell C2 which displays “s”. This represents the time of the current world record for running 100 meters, namely 9.572 seconds. The first dimensional equation we want to compute is the speed for this world record. So, the user types “Speed” into cell A3 which displays “Speed”. Next, the user types the formula “=B1/B2” into cell B3, which displays the result “10.45”, which is the 100 divided by 9.572. Note that this original formula does not reference the dimensional units of measure in the dimensional input quantities, which are found in cells C1 and C2. Next, the user types “mph” into cell C3 which displays “mph”. This is the desired output dimensional units of measure, miles per hour, for the dimensional output. With the cell B3 selected/highlighted, the user clicks on the ““DE Convert”” button. Cell C3 does not need to be highlighted or selected. Cell B3 then displays “23.3692” and C3 displays “mph”. In other words, the speed required to travel 100 meters in 9.572 seconds is 23.3692 miles per hour. This dimensional output quantity, represented by the pair of cells in B3 and C3, is the first dimensional calculation in the example.

The user next continues the example by typing “Marathon Distance” into cell A4, which displays “Marathon Distance”. The user then types “42.195” into cell B4 which displays “42.195”. The user then types “km” into cell C4 which displays “km”. This is the distance of the standard marathon, 42.195 kilometers.

Next, the user types “Marathon Sprint Duration” into cell A5 which displays “Marathon Sprint Duration”. Then, the user types the formula “=B4/B3” into cell B5 which displays “1.806”. 1.806 is the result of the division 42.195 divided by 23.3696. This formula does not reference any dimensional units of measure, only numerical values. Next, the user types “hr” into cell C5 which displays “hr”. Then, with the cell B5 selected or highlighted, the user clicks on the ““DE Convert”” button”. Cell C5 does not need to be highlighted or selected. This conversion replaces the contents of cells B5 and C5 with calls to the functions “DE” and “DEUnits”. The resulting dimensional calculation shows that if one could run an entire marathon at the speed of a world record 100 meter sprint champion, one could finish the marathon in 1.12 hours, significantly faster than the current world record for the marathon of just over two hours.

This example shows that the current embodiment of the present invention can successively, correctly use and compute dimensional formulas or equations, using whatever units the user finds most convenient. A simple indication of pressing the “DE Convert” button causes the properly linked reference cells to be inserted into pairs of cells so that the dimensional formula can be properly evaluated.

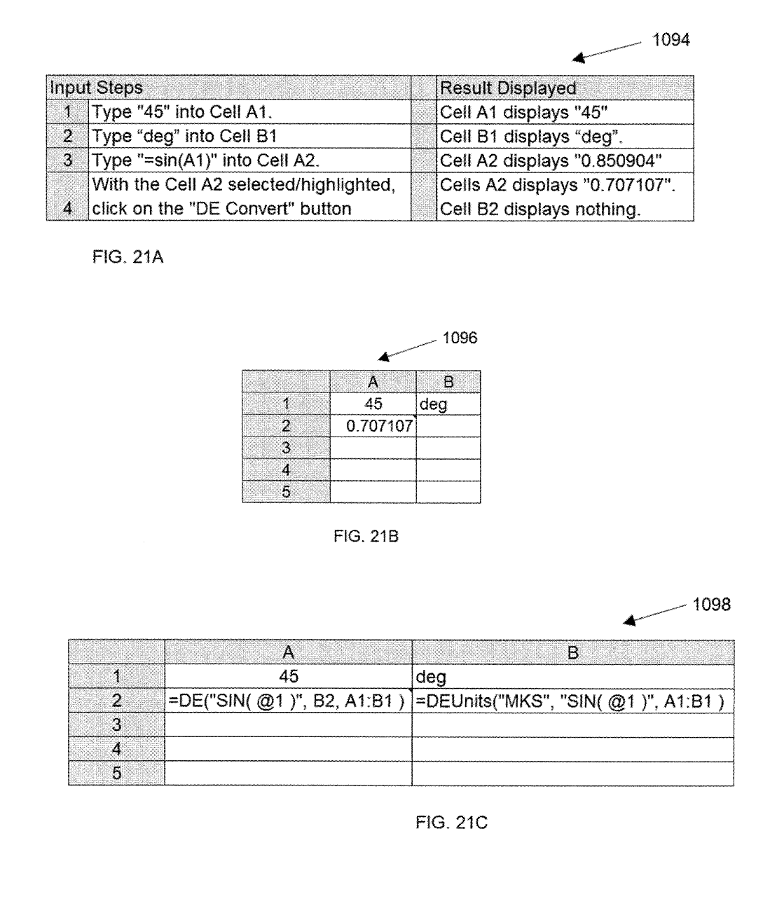

As the next example illustrating an aspect of use of the present invention, consider the trigonometric functions in a standard spreadsheet. Although most people think of these functions as taking inputs in degrees, in standard spreadsheets, the arguments are assumed to be in radians. So, sin(45) is the sine of 45 radians, which is 0.850904, not the sine of 45 degrees, which is 0.707107. If the user prefers to work in degrees, this is easily handled by the present invention as shown in FIGS. 21A-21C (collectively FIG. 21). The required user steps and displayed output table 1094 is shown in FIG. 21A. The final displayed output 1096 is shown in FIG. 21B. The final contents 1098 of the cells are shown in FIG. 21C.

The user types “45” into cell A1, which displays “45”. Next the user types “deg” into cell B1, which displays “deg”. Next the user types the formula “=sin(A1)” into cell A2. This formula does not reference the input dimensional units of measure in cell B1. Since the original formula only involves the number 45 in cell A1, cell A2 initially displays “0.850904” the sine of 45 radians. Next, with cell A3 highlighted or selected, the user clicks on the “DE Convert” button. Cell B3 does not need to be highlighted or selected. This conversion replaces the contents of cells A2 and B2 with calls to “DE” and “DEUnits”. The final result, as shown in displayed output 1096, is the sine of 45 degrees, which is 0.707107.

The present invention has been designed to correctly parse equations entered into a spreadsheet cell using standard spreadsheet syntax. It can perform addition, subtraction, multiplication, division, exponentiation, and calls to functions like sqrt and sine, and so forth. The associated manipulation of the input dimensional units of measure is carried along with the dimensional computations.

It will be recognized that the invention may be suitably applied and adapted to other environments consistent with the aspects of the invention described in the present disclosure. In particular, the present invention could be used for financial calculations. In this context, some of the essential base units would be one or more currencies (US dollars, British pounds, or the like), shares of stock, geometrical returns over various time windows, and volatilities describing the square root of variances of returns over various time window. Pre-defined functions would compute, for instance, the Black-Scholes price of an option given the current stock price, the strike price, the maturities, interest rate, dividend rate, and the kind of option, such as put and call.

An initial list of dimensions that can be usefully utilized with the present invention would include dimensionless measures (numbers, percent); angular measures (degrees, revolutions, arc minutes, arc seconds); angular velocity (rps, rpm); area or permeability (acre, hectare, darcy, millidarcy); electrical capacitance (farads, millifarads, microfarads, nanofarads); electric charge (coulombs); electric current (amperes, milliamps, microamps); electric potential (volts, millivolts, microvolts); electric resistance (ohms); electromagnetic inductance (henries); energy (joules, millijoules, kilojoules, megajoules, gigajoules, calories, kilocalories, btus, ergs, electron volts); force (newtons, kilonewtons, meganewtons, dynes, pounds force, ounce force, kilogram force, kips); frequency (hertz, kilohertz, megahertz, Becquerel, curies); length (meters, centimeters, millimeters, microns, nanometers, angstroms, kilometers, inches, feet, yards, miles, nautical miles, leagues, cubits, fathom, light years, wavelengths of krypton); magnetic field strength (oersted); magnetic flux (webers, maxwells); magnetic flux density (tesla, gauss); mass (kilogram, gram, milligram, slug, ton, tonne, ounce mass, pound mass, carat, grain, stones); mole (moles, kilomoles); power (watts, kilowatts, horsepower); pressure or stress (pascals, megapascals, psi, ksi, psf, atmospheres, bars, millibars, millimeters of mercury, inches of mercury, inches of water, torr); temperature (degrees Celsius, degrees Fahrenheit, degrees Kelvin, degrees Rankine); temperature difference (degrees Celsius, degrees Fahrenheit, degrees Kelvin, degrees Rankine); time (seconds, milliseconds, minutes, hours, days, weeks, years); velocity (mph, kph, knots, fps, fpm); dynamic viscosity (poise, centipoise poiseuille, Reynolds); kinematic viscosity (stoke, centistoke); volume (gallons, liters, milliliters, cc, barrels, board foot, bushels, cords, cups, fluidounces, pecks, pints, quarts, stere, tablespoon, teaspoon); currency (US dollars, British pounds, Euros, Japanese yen); prices, rents and tax rates; stock prices and trade sizes (USD/share, shares); chemical analysis units (heats of fusion, weight percent composition, ppm, ppb); statistical data (ages, death rates); medical quantities (dosages); and manufacturing tolerances.

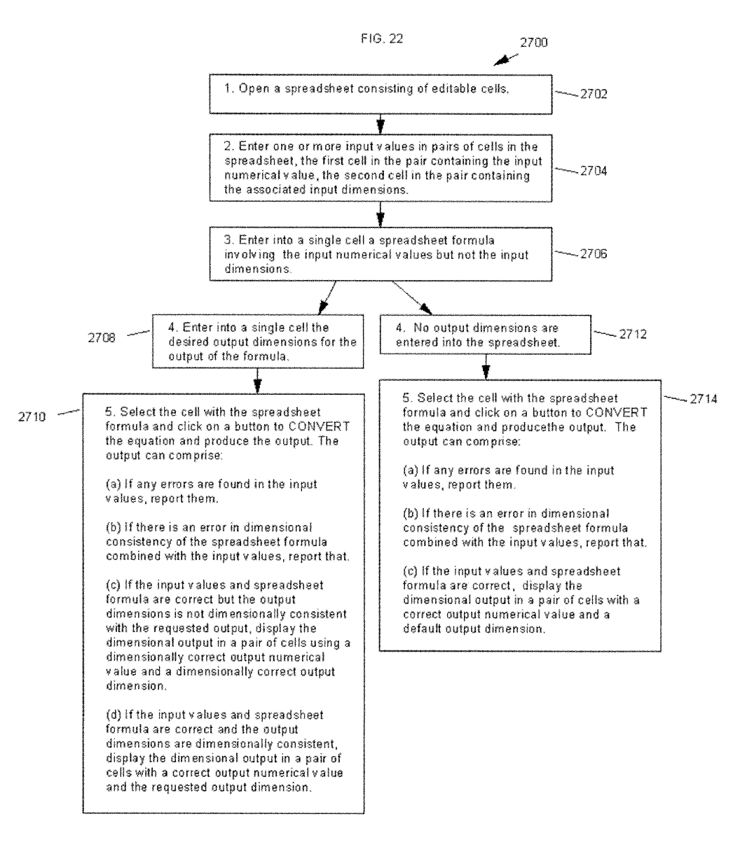

FIG. 22 shows a flow diagram illustrating the steps of a process 2700 embodying the present invention. In step 2702, a user opens a spreadsheet consisting of editable cells. In step 2704, the user enters one or more input values in pairs of cells in the spreadsheet, the first cell in the pair contains the input numerical value, the second cell in the pair contains the associated input dimension or dimensions. In step 2706, the user enters into a single cell a spreadsheet formula involving the input numerical values but not the input dimensions.

In the case where the user wishes to specify output dimensions, the next step 2708 requires the user to enter the desired output dimensions into a single cell. Then, in step 2710, the user selects the cell with the spreadsheet formula and clicks on a button or other indicator to “convert” the spreadsheet formula and produce the dimensionally correct output. Once the spreadsheet formula is converted, there are four possible outputs that can be displayed. The first possible output occurs if there are any errors found in the input values, such as misspelled or unrecognized input units. In this case, the spreadsheet displays an appropriate error message in the first output cell. The second possible output occurs if there is an error in dimensional consistency in the spreadsheet formula when combined with the input values. In this case, the error in dimensional consistency is reported. The third possible output occurs if the input values and spreadsheet formula are correct and consistent but the requested output dimension are not dimensionally consistent with the correct output of the formula. In this case, the output will be the correct dimensional output in a default set of dimensions that are dimensionally correct.

Finally, in the fourth possible output, the input, formula and requested output are all dimensionally consistent. In this case, the output is the correct output of the formula in the requested dimensional units.

In the case where the user does not wish to specify output dimensions, the step after 2706 is step 2712, in which the user does not enter any output units into any cells in the spreadsheet. Then, in step 2714, the user selects the cell with the spreadsheet formula and clicks on a button or other actuator to “convert” the spreadsheet formula and produce the dimensionally correct output. Once the spreadsheet formula is converted, there are three possible outputs that can be displayed. The first possible output occurs if there are any errors found in the input values, such as misspelled or unrecognized input units. In this case, the spreadsheet displays an appropriate error message in the first output cell. The second possible output occurs if there is an error in dimensional consistency in the spreadsheet formula when combined with the input values. When this happens, an error message is reported. In the third possible output, the input, formula and requested output are all dimensionally consistent. In this case, the output is the correct output of the formula in the requested dimensional units.

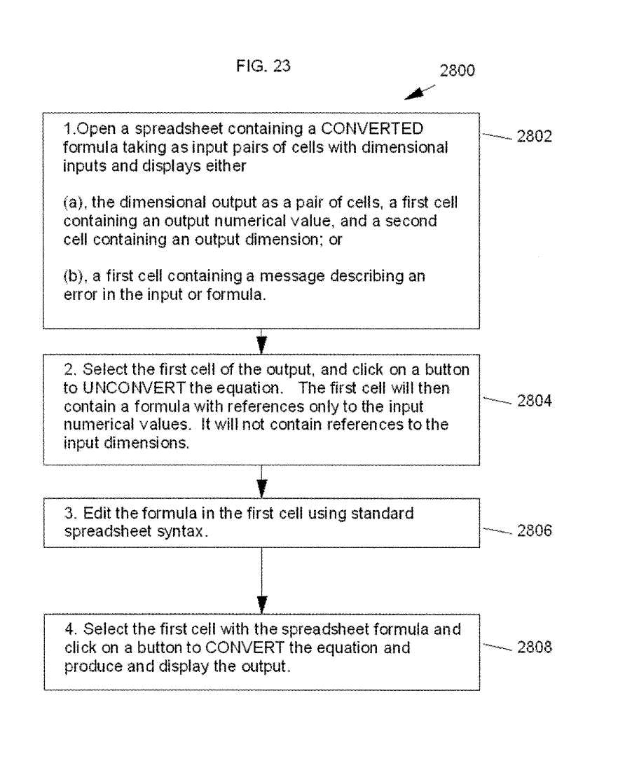

FIG. 23 shows a flow diagram illustrating the steps of a process 2800 in accordance with the present invention in which the user wishes to edit or alter the formula in a spreadsheet that has already been converted into a dimensional formula using the present invention. Such editing or alteration, for example, occurs if the user makes a mistake in the formula or changes his or her mind about which formula he or she wanted to compute. In step 2802, a user opens a spreadsheet containing a converted formula taking as input pairs of cells with dimension inputs and displays either: (a), the dimensional output as a pair of cells, a first cell containing an output numerical value and a second cell containing an output dimension; or (b), a first cell containing a message describing an error in the input or formula. In step 2804, the user selects the first cell of the output, and clicks on a button to “unconvert” the equation or formula. The first cell then contains a formula with references only to the input numerical values. It will not contain references to the input dimensions. In step 2806, the user edits the formula in the first cell using standard spreadsheet syntax. In step 2808, the user selects the first cell which contains the altered formula and clicks on a button to “convert” the equation and produce and display the appropriate output. There are many possible outputs as described in the process 2700 of FIG. 22 in steps 2710 and 2714.

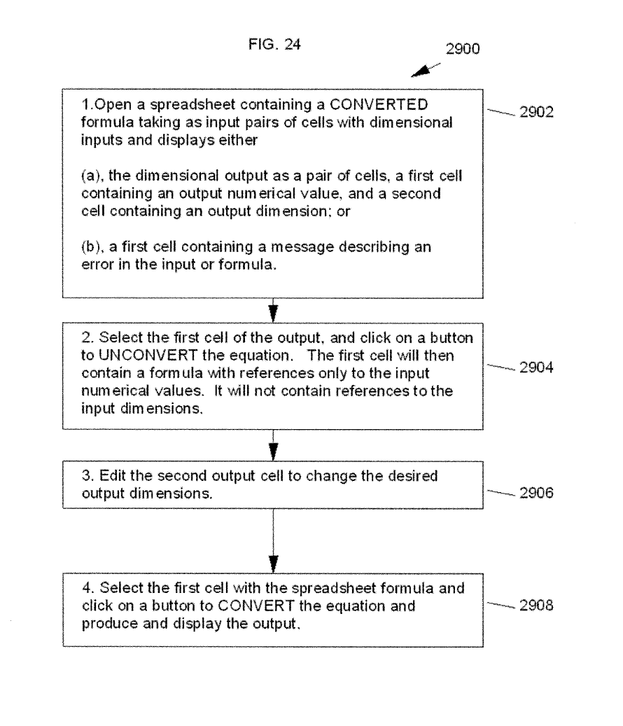

FIG. 24 shows a process 2900 in accordance with the present invention in which the user wishes to edit or alter the output units of a dimensional calculation in a spreadsheet that has already been converted into a dimensional formula using the present invention. This editing or alteration could occur if the user made a mistake in the units he or she originally requested or changed his or her mind about which units he or she wanted to have the final results displayed in. In step 2902, a user opens a spreadsheet containing a converted formula taking as input pairs of cells with dimension inputs and displays either: (a), the dimensional output as a pair of cells, a first cell containing an output numerical value and a second cell containing an output dimension; or (b), a first cell containing a message describing an error in the input or formula. In step 2904, the user selects the first cell of the output, and clicks on a button to “unconvert” the equation or formula. The first cell will then contain a formula with references only to the input numerical values. It will not contain references to the input dimensions. In step 2906, the user edits the formula in the second output cell so that it contains the desired units for the output. In step 2908, the user selects the first cell which contains the altered formula and clicks on a button to “convert” the equation and produce and display the appropriate output. There are many possible outputs as described in the process 2700 of FIG. 22 in steps 2710 and 2714.

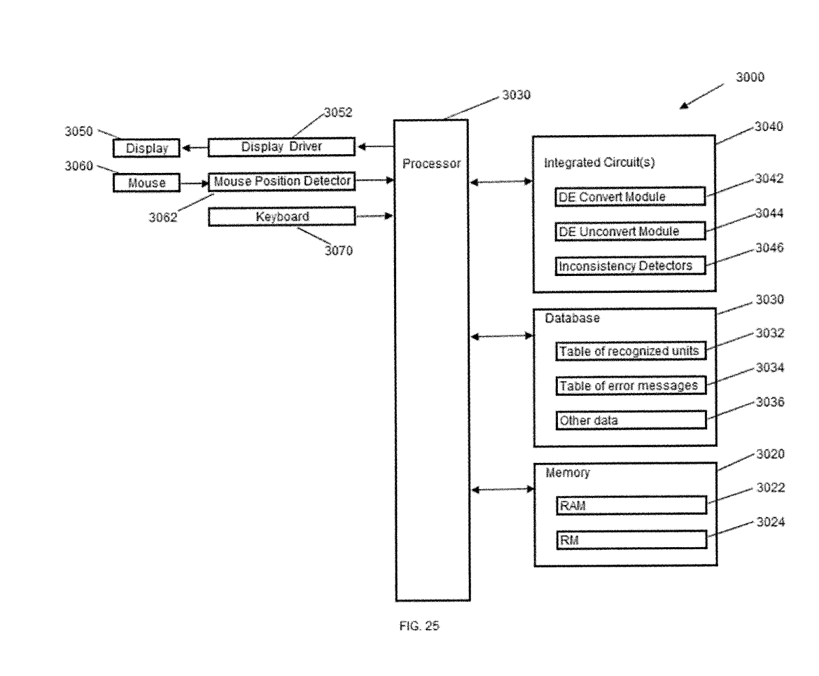

While the above discussion is primarily in the context of software operations, such as an Excel™ spreadsheet add-in, it will be recognized that a circuit based approach is also possible. FIG. 25 shows a circuit based implementation 3000 of the present invention in which a processor 3010, such as a programmed microprocessor, has associated memory 3020 including random access memory (RAM) 3022 and read only memory (ROM) 3024, storing a sequence of program instructions. Processor 3010 also communicates with database storage 3030 which suitably includes a table of recognized dimensional units 3032, such as the exemplary units discussed throughout the application generally and those dimensional units specifically listed at pages 50 and 51 above. Database storage 3030 may also suitably store a table error message 3034 to support the display of error message as discussed above. Other data 3036 supports the operations described above may also be advantageously stored.

Processor 3010 also communicates with an integrated circuit or circuits 3040 which implement a circuit embodiment of a DE convert module 3042, a DE unconvert module 3044 and inconsistency databases 3046, as well as, any other circuits needed or desired to implement the functionality of the present invention as described above. An application specific integrated circuit (ASIC) or ASICs, a field programmable gate array (FPGA) or FPGAs, circuit based stat machine or the like may be suitably employed to implement the desired functionality. It will be recognized that such functionality may alternatively be implemented in software or by a mix of hardware and software.

The processor 3010 controls a display driver 3052 to drive a display 3050 to display spreadsheets and other displays of cells and cell data as discussed above in accordance with the present invention. Mouse 3060 can be utilized to position a cursor over a desired portion of a spreadsheet display and then clicked to activate a DE Convert function, a DE Unconvert function or the like as described above in further detail. A mouse position detector 3062 provides mouse position data to the processor 3010. Additionally, keyboard 3070 provides key stroke inputs, such as the exemplary user entry data discussed above, to the processor 3010.

Thus, in operation, a user may use keyboard 3070 to enter numerical data and dimensional units. The mouse 3060 may be used to select a cell and then to select a function, such as “DE Convert”. The processor then supplies the necessary inputs to the DE convert module 3042 which in return generates the necessary cell linkages and provides the processor 3010 with the data inputs needed for the processor to operate to controllably drive display driver 3052 to drive the display 3050 to display the correct spreadsheet results.

While the present invention has been disclosed in the context of various aspects of presently preferred embodiments, it will be recognized that the invention may be suitably applied to other environments consistent with the claims which follow.

We claim:

1. A non-transitory computer-readable medium having stored thereon computer-executable instructions which when executed by a computer perform a method for computing formulas involving dimensional quantities located in pairs of cells in a spreadsheet application workbook, the method comprising:
generating at least one pair of input cells in the spreadsheet application workbook comprising a first input cell containing a numeric value and a second input cell containing a dimensional unit of measure associated with the first cell value;
generating an output pair of cells comprising a first output cell containing an original spreadsheet formula referencing the first input cells of the input cell pairs containing the numeric values but not the second input cells of the input cell pairs containing the dimensional units of measure associated with the first input cell values;
receiving an indication to alter the formula in the first output cell containing the original spreadsheet formula;
altering the formula in the first output cell of the output cell pair so that it references both cells in the input cell pairs and computes the original formula so that the result is either a dimensionally accurate and consistent result displayed in the pair of output cells, or an error message if a dimensionally accurate and consistent result cannot be computed; and
electronically outputting the result in the output cell pair using an output device.

2. The method of claim 1 where the second output cell contains the desired units of measure for the dimensionally accurate and consistent results of the formula and the result is output in the desired units of measure if they are dimensionally consistent with the output result.

3. The method of claim 1 where the second output cell contains an indication of a system of units for the desired units of measure for the dimensionally accurate and consistent results of the formula and the result is output in the system of units if it is dimensionally consistent with the output result.

4. The method of claim 1 where the indication is a mouse-click by the user on a button displayed on the computer or a sequence of key strokes on a keyboard.

5. The method of claim 1 where a second indication is received, upon which the formula in the first output cell is restored to the original formula that does not reference the second cells of the input pairs of cells.

6. The method of claim 1 wherein a second input cell containing a dimensional unit of measure associated with a first cell value uses a combination of two or more of the following dimensional units of measure: dimensionless measures, angular measures, angular velocity, area or permeability, electrical capacitance, electric charge, electric current, electric potential, electric resistance, electromagnetic inductance, energy, force, length, magnetic field strength, magnetic flux, magnetic flux density, mass, mole, power, pressure or stress, temperature, temperature difference, time, velocity, dynamic viscosity, kinematic viscosity, volume, currency, prices, rents and tax rates, stock prices and stock trade sizes, chemical analysis units, statistical data, medical quantities, and manufacturing tolerances.

7. A system for computing formulas involving dimensional quantities located in pairs of cells in a spreadsheet application workbook, and displaying computed results comprising:
a processor; and
a memory having computer-executable instruction stored thereon, wherein execution of the computer-executable instructions results in:
entering data into at least one pair of input cells in the spreadsheet application workbook, each pair of input cells comprising a first input cell and a second input cell, the first input cell containing a numeric value and a second input cell containing a dimensional unit of measure associated with the first cell value;
entering into an output pair of cells comprising a first output cell and a second output cell, the first output cell containing an original spreadsheet formula referencing the first input cells of the input cell pairs containing the numeric values but not the second input cells of the input cell pairs containing the dimensional units of measure associated with the first input cell values;
in response to receiving an indication to alter the formula in the first output cell, altering the formula in the first output cell of the output cell pair so that it references both cells in the input cell pairs and computes the original formula so that the result is either a dimensionally accurate and consistent result displayed in the pair of output cells, or an error message if a dimensionally accurate and consistent result cannot be computed; and
electronically displaying the result in the output cell pair using a display device.

8. The system of claim 7 where the second output cell contains the desired units of measure for the dimensionally accurate and consistent results of the formula and the result is output in the desired units of measure if they are dimensionally consistent with the output result.

9. The system of claim 7 where the second output cell contains an indication of a system of units for the desired units of measure for the dimensionally accurate and consistent results of the formula and the result is output in the system of units if it is dimensionally consistent with the output result.

10. The system of claim 7 where the indication is a mouse-click by the user on a button displayed on the computer or a sequence of key strokes on a keyboard.

11. The system of claim 7 where a second indication is received, upon which the formula in the first output cell is restored to the original formula that does not reference the second cells of the input pairs of cells.

12. The system of claim 7 wherein a second input cell containing a dimensional unit of measure associated with a first cell value uses a combination of two or more of the following dimensional units of measure: dimensionless measures, angular measures, angular velocity, area or permeability, electrical capacitance, electric charge, electric current, electric potential, electric resistance, electromagnetic inductance, energy, force, length, magnetic field strength, magnetic flux, magnetic flux density, mass, mole, power, pressure or stress, temperature, temperature difference, time, velocity, dynamic viscosity, kinematic viscosity, volume, currency, prices, rents and tax rates, stock prices and stock trade sizes, chemical analysis units, statistical data, medical quantities, and manufacturing tolerances.

13. A non-transitory computer-readable medium having stored thereon computer-executable instructions which when executed by a computer perform a method of computing formulas involving dimensional quantities located in pairs of cells in a spreadsheet application workbook, the method comprising:
establishing at least one pair of input cells in the spreadsheet application workbook comprising a first input cell containing a numeric value and a second input cell containing a dimensional unit of measure associated with the first cell value;
establishing an output pair of cells comprising a first output cell containing an original spreadsheet formula referencing the first input cells of the input cell pairs containing the numeric values but not the second input cells of the input cell pairs containing the dimensional units of measure associated with the first input cell values;
receiving an indication to alter the formula in the first output cell containing the original spreadsheet formula;
altering the formula in the first output cell of the output cell pair so that it references both cells in the input cell pairs and computes the original formula so that the result is either a dimensionally accurate and consistent result displayed in the pair of output cells, or an error message if a dimensionally accurate and consistent result cannot be computed; and
electronically outputting the result in the output cell pair using an output device.

14. The computer-readable storage medium of claim 13 where the second output cell contains the desired units of measure for the dimensionally accurate and consistent results of the formula, and further comprising:
outputting the result in the desired units of measure if the units are dimensionally consistent with the output result.

15. The computer-readable storage medium of claim 13 where the second output cell contains an indication of a system of units for the desired units of measure for the dimensionally accurate and consistent results of the formula, and further comprising:
outputting the result in the system of units if the results are dimensionally consistent with the output result.

16. The computer-readable storage medium of claim 13 where the indication is the having received a mouse-click by the user on a button displayed on the computer or a sequence of key strokes on a keyboard.

17. The computer-readable storage medium of claim 13 where a second indication is received, upon which the formula in the first output cell is restored to the original formula that does not reference the second cells of the input pairs of cells.

18. The computer-readable storage medium of claim 13 wherein a second input cell containing a dimensional unit of measure associated with a first cell value uses a combination of two or more of the following dimensional units of measure: dimensionless measures, angular measures, angular velocity, area or permeability, electrical capacitance, electric charge, electric current, electric potential, electric resistance, electromagnetic inductance, energy, force, length, magnetic field strength, magnetic flux, magnetic flux density, mass, mole, power, pressure or stress, temperature, temperature difference, time, velocity, dynamic viscosity, kinematic viscosity, volume, currency, prices, rents and tax rates, stock prices and stock trade sizes, chemical analysis units, statistical data, medical quantities, and manufacturing tolerances.

19. A non-transitory computer-readable medium having stored thereon computer-executable instructions which when executed by a computer perform a method for computing formulas involving dimensional quantities located in pairs of cells in a spreadsheet application workbook, the method comprising:
generating at least one pair of input cells in the spreadsheet application workbook comprising a first input cell containing a numeric value and a second input cell containing a dimensional unit of measure associated with the first cell value;
generating an output pair of cells comprising a first output cell containing an original spreadsheet formula referencing the first input cells of the input cell pairs containing the numeric values but not the second input cells of the input cell pairs containing the dimensional units of measure associated with the first input cell values, and a second output cell containing original contents that do not reference the first input cells of the input cell pairs;
receiving an indication to alter the formula in the first output cell containing the original spreadsheet formula and the contents of the second output cell that does not reference the first input cells;
altering the contents of the second output cell so that the second output cell contains a formula that references both cells of the input pair of cells;
altering the formula in the first output cell of the output cell pair so that the first output cell references both cells in the input cell pairs as well as the second output cell;
determining the results of the formulas in both output cells so that the result is either a dimensionally accurate and consistent result displayed in the pair of output cells, or an error message if a dimensionally accurate and consistent result cannot be computed; and
electronically outputting the result in the output cell pair using an output device.

20. The method of claim 19 where only the first output cell is selected in the spreadsheet application when the indication is received.

21. The method of claim 19 where the indication is a mouse-click by the user on a button displayed on the computer or a sequence of key strokes on a keyboard.

22. The method of claim 19 where a second indication is received, upon which the formula in the first output cell is restored to the original formula that does not reference the second cells of the input pairs of cells and the formula in the second output cell is restored to the original second output cell contents.

23. The method of claim 19 wherein a second input cell containing a dimensional unit of measure associated with a first cell value uses a combination of two or more of the following dimensional units of measure: dimensionless measures, angular measures, angular velocity, area or permeability, electrical capacitance, electric charge, electric current, electric potential, electric resistance, electromagnetic inductance, energy, force, length, magnetic field strength, magnetic flux, magnetic flux density, mass, mole, power, pressure or stress, temperature, temperature difference, time, velocity, dynamic viscosity, kinematic viscosity, volume, currency, prices, rents and tax rates, stock prices and stock trade sizes, chemical analysis units, statistical data, medical quantities, and manufacturing tolerances.
